(19) United States
(12) Patent Application Publication
(10) Pub. No.: US 2025/0227312 A1
(43) Pub. Date: Jul. 10, 2025

(54) SYSTEMS AND METHODS FOR MULTI-FILTER VIDEO DECODING WITH PARTIAL-BLOCK FILTERING

(71) Applicant: QUALCOMM Incorporated, San Diego, CA (US)

(72) Inventors: Vikrant MAHAJAN, Dinanagar (IN); Sandeep Nellikatte SRIVATSA, Bangalore (IN); Ashish MISHRA, Bhubaneswar (IN)

(21) Appl. No.: 18/408,180

(22) Filed: Jan. 9, 2024

(51) Int. Cl. H04N 19/86; H04N 19/117; H04N 19/167; H04N 19/176

(52) U.S. Cl. CPC H04N 19/86; H04N 19/117; H04N 19/167; H04N 19/176

(57) ABSTRACT

Video decoding systems and techniques are described. In some examples, a decoder applies a first filter to a plurality of sub-blocks of a block of the video data to generate a filtered plurality of sub-blocks. The plurality of sub-blocks are less than an entirety of sub-blocks within the block. The decoder also applies the first filter to at least one line of pixels in an additional sub-block of the block to generate a filtered portion of the additional sub-block. The at least one line of pixels in the additional sub-block is filtered using the first filter without filtering an entirety of the additional sub-block using the first filter. The additional sub-block is adjacent to at least one of the plurality of sub-blocks. The decoder applies a second filter to the filtered plurality of sub-blocks and the filtered portion of the additional sub-block to generate a second filtered plurality of sub-blocks.

### FIELD

This application is related to video decoding, decompression, and filtering. More specifically, this application relates to systems and methods of performing improved video decoding of a block of video data, including by applying a first filter a sub-block of the block as well as to a portion of an adjacent sub-block of the block, which allows a second filter to be applied to an increased amount of the block relative to the same process without the first filter applied to the portion of the adjacent sub-block. Applying the first filter to the portion of the adjacent sub-block and using the resulting filtered data to apply the second filter to more of the block ultimately increases the amount of the block that can be processed during that block's processing cycle and reduces the amount of the block to be stored in a neighboring block buffer for processing during the next block's processing cycle.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, cellular or satellite radio telephones, mobile phones (e.g., so-called “smart phones”), video teleconferencing devices, video streaming devices, and the like. Such devices allow video data to be processed and output for consumption. Digital video data includes large amounts of data to meet the demands of consumers and video providers. For example, consumers of video data desire video of the utmost quality, with high fidelity, resolutions, frame rates, and the like. The large amount of video data needed to meet these demands places a burden on communication networks and devices that process and store the video data.

Digital video devices can implement video coding techniques to compress video data. Video coding can be performed according to one or more video coding standards or formats. For example, video coding standards or formats include versatile video coding (VVC), Essential Video Coding (EVC), high-efficiency video coding (HEVC), VP8, VP9, advanced video coding (AVC), MPEG-2 Part 2 coding (MPEG stands for moving picture experts group), among others, as well as proprietary video codecs/formats such as AOMedia Video 1 (AV1) that was developed by the Alliance for Open Media and SMPTE 421 (also known as VC-1), among others. Video coding generally utilizes prediction methods (e.g., inter prediction, intra prediction, or the like) that take advantage of redundancy present in video images or sequences. A goal of video coding techniques is to compress video data into a form that uses a lower bit rate, while avoiding or minimizing degradations to video quality. A goal of video decoding techniques is to recreate the original video data as closely as possible from the compressed video data. With ever-evolving video services becoming available, coding and decoding techniques with improved coding and decoding efficiencies are needed.

### BRIEF SUMMARY

In some examples, systems and techniques are described for video decoding. Video decoding systems and techniques are described. In some examples, a decoder applies a first filter (e.g., a deblocking filter) to a plurality of sub-blocks of a block of the video data to generate a filtered plurality of sub-blocks. The plurality of sub-blocks are less than an entirety of sub-blocks within the block. The decoder also applies the first filter to at least one line of pixels in an additional sub-block of the block to generate a filtered portion of the additional sub-block. The at least one line of pixels in the additional sub-block is filtered using the first filter without filtering an entirety of the additional sub-block using the first filter. The additional sub-block is adjacent to at least one of the plurality of sub-blocks. The decoder applies a second filter (e.g., a constrained directional enhancement filter, a loop restoration filter, a sample adaptive offset filter, an adaptive loop filter, or another filter) to the filtered plurality of sub-blocks and the filtered portion of the additional sub-block to generate a second filtered plurality of sub-blocks. Applying the first filter to the at least one line of pixels in the additional sub-block and using the resulting filtered portion of the additional sub-block during application of the second filter allows the second filter to be applied to more of the block, ultimately increasing the amount of the block that can be processed during the block's processing cycle and reducing the amount of the block to be stored in a neighboring block buffer for processing during a next block's processing cycle.

In one example, an apparatus for video decoding is provided. The apparatus includes a memory and one or more processors (e.g., implemented in circuitry) coupled to the memory. The one or more processors are configured to and can: apply a first filter to a plurality of sub-blocks of a block of video data to generate a filtered plurality of sub-blocks, the plurality of sub-blocks being less than an entirety of sub-blocks within the block; apply the first filter to at least one line of pixels in an additional sub-block of the block to generate a filtered portion of the additional sub-block, wherein the at least one line of pixels in the additional sub-block is filtered using the first filter without filtering an entirety of the additional sub-block using the first filter, and wherein the additional sub-block is adjacent to at least one of the plurality of sub-blocks; and apply a second filter to the filtered plurality of sub-blocks and the filtered portion of the additional sub-block to generate a second filtered plurality of sub-blocks.

In another example, a method of video decoding is provided. The method includes: applying a first filter to a plurality of sub-blocks of a block of video data to generate a filtered plurality of sub-blocks, the plurality of sub-blocks being less than an entirety of sub-blocks within the block; applying the first filter to at least one line of pixels in an additional sub-block of the block to generate a filtered portion of the additional sub-block, wherein the at least one line of pixels in the additional sub-block is filtered using the first filter without filtering an entirety of the additional sub-block using the first filter, and wherein the additional sub-block is adjacent to at least one of the plurality of sub-blocks; and applying a second filter to the filtered plurality of sub-blocks and the filtered portion of the additional sub-block to generate a second filtered plurality of sub-blocks.

In another example, a non-transitory computer-readable medium is provided that has stored thereon instructions that, when executed by one or more processors, cause the one or more processors to: apply a first filter to a plurality of sub-blocks of a block of video data to generate a filtered plurality of sub-blocks, the plurality of sub-blocks being less than an entirety of sub-blocks within the block; apply the first filter to at least one line of pixels in an additional sub-block of the block to generate a filtered portion of the additional sub-block, wherein the at least one line of pixels in the additional sub-block is filtered using the first filter without filtering an entirety of the additional sub-block using the first filter, and wherein the additional sub-block is adjacent to at least one of the plurality of sub-blocks; and apply a second filter to the filtered plurality of sub-blocks and the filtered portion of the additional sub-block to generate a second filtered plurality of sub-blocks.

In another example, an apparatus for video decoding is provided. The apparatus includes: means for applying a first filter to a plurality of sub-blocks of a block of video data to generate a filtered plurality of sub-blocks, the plurality of sub-blocks being less than an entirety of sub-blocks within the block; means for applying the first filter to at least one line of pixels in an additional sub-block of the block to generate a filtered portion of the additional sub-block, wherein the at least one line of pixels in the additional sub-block is filtered using the first filter without filtering an entirety of the additional sub-block using the first filter, and wherein the additional sub-block is adjacent to at least one of the plurality of sub-blocks; and means for applying a second filter to the filtered plurality of sub-blocks and the filtered portion of the additional sub-block to generate a second filtered plurality of sub-blocks.

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example of a system including an encoding device and a decoding device, in accordance with some examples;

FIG. 2 is a block diagram illustrating a decoder system that includes and applies a first filter, a second filter, and a third filter, in accordance with some examples;

FIG. 3 is a block diagram illustrating a decoder system in which the first filter is a deblocking (DB) filter, the second filter is a sample adaptive offset (SAO) filter, and the third filter is an adaptive loop filter (ALF), in accordance with some examples;

FIG. 4 is a block diagram illustrating a decoder system in which the first filter is a deblocking (DB) filter, the second filter is a constrained directional enhancement filter (CDEF), and the third filter is a loop restoration (LR) filter, in accordance with some examples;

FIG. 5 is a conceptual diagram illustrating a block layout with a block boundary between a first block and a second block, with both blocks divided into sub-blocks, in accordance with some examples;

FIG. 6 is a block diagram illustrating a decoder system that applies a first filter and a second filter to a block of video data, in accordance with some examples;

FIG. 7 is a block diagram illustrating a decoder system that applies a first filter and a second filter to a block of video data, with partial sub-block application of the first filter used to allow the second filter to be applied to more of the block than under the decoder system of FIG. 6, in accordance with some examples;

FIG. 8 is a flow diagram illustrating a codec process, in accordance with some examples; and

FIG. 9 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Video coding devices implement video compression techniques to encode and decode video data efficiently. Video compression techniques may include applying different prediction modes, including spatial prediction (e.g., intra-frame prediction or intra-prediction), temporal prediction (e.g., inter-frame prediction or inter-prediction), inter-layer prediction (across different layers of video data, and/or other prediction techniques to reduce or remove redundancy inherent in video sequences. A video encoder can partition each picture of an original video sequence into rectangular regions referred to as video blocks or coding units (described in greater detail below). These video blocks may be encoded using a particular prediction mode.

Video blocks may be divided in one or more ways into one or more groups of smaller blocks. Blocks can include coding tree blocks, prediction blocks, transform blocks, or other suitable blocks. References generally to a “block,” unless otherwise specified, may refer to such video blocks (e.g., coding tree blocks, coding blocks, prediction blocks, transform blocks, or other appropriate blocks or sub-blocks, as would be understood by one of ordinary skill. Further, each of these blocks may also interchangeably be referred to herein as “units” (e.g., coding tree unit (CTU), coding unit, prediction unit (PU), transform unit (TU), or the like). In some cases, a unit may indicate a coding logical unit that is encoded in a bitstream, while a block may indicate a portion of video frame buffer a process is target to.

For inter-prediction modes, a video encoder can search for a block similar to the block being encoded in a frame (or picture) located in another temporal location, referred to as a reference frame or a reference picture. The video encoder may restrict the search to a certain spatial displacement from the block to be encoded. A best match may be located using a two-dimensional (2D) motion vector that includes a horizontal displacement component and a vertical displacement component. For intra-prediction modes, a video encoder may form the predicted block using spatial prediction techniques based on data from previously encoded neighboring blocks within the same picture.

The video encoder may determine a prediction error. For example, the prediction can be determined as the difference between the pixel values in the block being encoded and the predicted block. The prediction error can also be referred to as the residual. The video encoder may also apply a transform to the prediction error (e.g., a discrete cosine transform (DCT) or other suitable transform) to generate transform coefficients. After transformation, the video encoder may quantize the transform coefficients. The quantized transform coefficients and motion vectors may be represented using syntax elements, and, along with control information, form a coded representation of a video sequence. In some instances, the video encoder may entropy code syntax elements, thereby further reducing the number of bits needed for their representation.

The AV1 video codec (alternatively or additionally referred to herein as the AV1 video coding format) specifies a decoder that, in some examples, processes video data using a deblocking (DB) filter, a constrained directional enhancement filter (CDEF), an upscaler, and a loop restoration (LR) filter, in that order, as part of decoding the video data. The VVC video codec (alternatively or additionally referred to herein as the VVC video coding format) specifies a decoder that, in some examples, processes video data using a deblocking (DB) filter, a sample adaptive offset (SAO) filter, and an adaptive loop filter (ALF), in that order, as part of decoding the video data.

Some video codecs and/or formats, such as AV1 and VVC, specify that for DB filtering, the decoder first vertically filters the video data, and then horizontally filters the pixel data. In some examples, the vertical DB filtering algorithm uses 13-tap filtering for at least some vertical edges. Thus, to perform vertical DB filtering on a specified edge of a block (e.g., a largest coding block known as a superblock) or a constituent block resulting from partitioning of a larger block (e.g., sub-block of video data), the vertical DB filter algorithm uses both pixel data from 7 columns of pixels to the left of (leftward of) the specified edge and 7 columns of pixels to the right of the specified edge, and modifies pixel data in up to 6 columns of pixels to the left of (leftward of) the specified edge and 6 columns of pixels to the right of the specified edge. Thus, to perform vertical DB filtering on a column of pixel data that is at (or alternatively within a range of pixel columns or pixel rows) the left or right edge of a block (e.g., a superblock), the DB filter algorithm may need up to 7 columns of pixel data from a neighboring superblock. However, in some examples, some video codecs and/or formats, such as AV1 and VVC, use a neighbor line buffer that stores pixel data from the left neighbor block to the left of the block being filtered. In such examples, there may be columns of pixels in sub-blocks along or near the right edge of a specified block that cannot undergo vertical DB filtering during a DB-filtering process for the specified block, due to lack of pixel data from a right neighboring block to the right of the specified block. The lack of vertical DB filtering for these portions of the specified block during the DB-filtering process for the specified block can prevent further filtering processes for the specified block, such as horizontal DB filtering and/or application of further filter(s) (e.g., SAO filter, ALF, CDEF, and/or LR filter). As a result, these unfiltered or incompletely filtered portions of the specified block can be stored in the neighbor line buffer for decoding the next block in the video data.

In some examples, a block has a size of 64 pixels by 64 pixels, and is divided into sub-blocks of 4 pixels by 4 pixels. In some examples, a block size, or a sub-block size, may be 2 pixels by 2 pixels, 3 pixels by 3 pixels, 4 pixels by 4 pixels, 5 pixels by 5 pixels, 6 pixels by 6 pixels, 8 pixels by 8 pixels, 10 pixels by 10 pixels, 12 pixels by 12 pixels, 16 pixels by 16 pixels, 32 pixels by 32 pixels, 64 pixels by 64 pixels, 128 pixels by 128 pixels, 256 pixels by 256 pixels, 712 pixels by 712 pixels, or another size. Generally, DB filtering is performed for an entire sub-block at a time. In such examples, in a given row of sub-blocks, the two rightmost sub-blocks in the row cannot be fully DB-filtered, since the vertical DB filter uses pixel data from 7 pixels on the left and right sides of a given vertical edge.

In some examples, CDEF filtering filters an 8 pixel by 8 pixel area at a time in the luma space, and a 4 pixel by 4 pixel area at a time in the chroma space. In some examples, the CDEF filtering algorithm uses 5-tap filtering. Thus, to filter a specified area of pixels using CDEF filtering, the CDEF filtering algorithm uses both pixel data from 2 columns of pixels to the left of the specified area of pixels and 2 columns of pixels to the right of the specified area of pixels. In some examples, any data that the CDEF filtering algorithm uses for CDEF filtering should already be fully DB filtered (e.g., vertically DB filtered as well as horizontally DB filtered). Thus, in order to perform CDEF filtering on a pixel that is 9 pixels to the left of a right edge of the block, the pixel data in the pixels that are 8 and 7 pixels to the left of the right edge of the block would need to be DB filtered. However, under traditional decoding techniques, the pixel data in in the pixels that are 8 and 7 pixels to the left of the right edge of the block is not fully DB filtered. This pixel data can be can be missing horizontal DB filtering and/or vertical DB filtering. For instance, this pixel data can be vertically DB filtered without being horizontally DB filtered. This, in turn, can prevent certain sub-blocks (e.g., the third and fourth to the left of the right edge) from being CDEF-filtered.

In some examples, SAO filtering and/or ALF filtering can filter a 4 pixel by 4 pixel area at a time in the luma and chroma spaces. In some examples SAO filtering uses 3-tap filtering, Thus, to filter a specified area of pixels using SAO filtering, the SAO filtering algorithm uses both pixel data from 1 columns of pixel to the left of the specified area of pixels and 1 columns of pixels to the right of the specified area of pixels. In some examples, any data that the SAO filtering algorithm uses for SAO filtering should already be fully DB filtered (e.g., vertically DB filtered as well as horizontally DB filtered). Thus, in order to perform SAO filtering on a pixel that is 9 pixels to the left of a right edge of the block, the pixel data in pixel(s) that are 8 pixels to the left of the right edge of the block would need to be DB filtered. However, under traditional decoding techniques, the pixel data in in the pixel(s) that are 8 pixels to the left of the right edge of the block would need is not fully DB filtered. This pixel data can be missing horizontal DB filtering and/or vertical DB filtering. For instance, this pixel data can be vertically DB filtered without being horizontally DB filtered. This, in turn, can prevent certain sub-blocks (e.g., the third to the left of the right edge) from being SAO-filtered.

In examples where the vertical DB filtering algorithm uses 13-tap filtering for at least some edges, vertical DB filtering is possible for two columns of pixels that are 7 and 8 pixels to the left of the right edge of the block, respectively. These columns are in the second-closest sub-block to the right edge, in examples where the sub-blocks are 4 pixels by 4 pixels in size. For instance, the column of pixels that is 8 pixels to the left of the right edge of the block is neither used nor modified by vertical DB filtering of the right edge of the block, while the column of pixels that is 7 pixels to the left of the right edge of the block is used but not modified by the vertical DB filtering of the right edge of the block. The horizontal edges of this sub-block can be horizontally DB-filtered for those two columns, without being filtered for the rest of the sub-block. Thus, these two columns of pixels can be fully DB filtered. This allows areas of pixels in the third and fourth sub-blocks from the right edge of the block to be filtered using a second filter such as a CDEF filter or SAO filter, since the second filter can be applied using these two columns of pixels following DB-filtering. The SAO filter could even be applied with only one of the two columns. Applying the second filter to these sub-blocks in turn allows for filtering and decoding of an increase area of these sub-blocks within the cycle for that block, and reduces how much block data of the block is put off for later filtering and/or decoding through storage in a neighboring block line buffer.

Once the decoder system moves on from decoding and/or filtering the specified block to decoding and/or filtering the next block to the right of the specified block, the decoder system can store less of the specified block in a neighboring block line buffer (e.g., left line buffer) for use in decoding and/or filtering the next block. For instance, the third and/or fourth sub-blocks from the right edge of the specified block might otherwise need to be added to the neighboring block line buffer, but no longer need to be based on use of the partial-sub-block filtering technique (e.g., applying the first filter to one or two extra columns and passing the filtered columns to the second filter) described above and otherwise herein, and the increased area of the specified block that becomes filtered through the second filter (and/or a third filter and/or any further filters) that the partial-sub-block filtering technique makes possible. In some examples, the systems and techniques described herein decrease how much data is to be stored in the neighboring block line buffer by 44%.

In some examples, the systems and methods described herein describe a decoder system. In some examples, the decoder system reads video data from a block of a video frame. The block includes a plurality of sub-blocks. In some examples, the sub-blocks have dimensions of 4 pixels by 4 pixels. In some examples, a decoder system applies a first filter, such as a deblocking (DB) filter, to a plurality of sub-blocks of a block of the video data to generate a filtered plurality of sub-blocks. The plurality of sub-blocks are less than an entirety of sub-blocks within the block. The decoder also applies the first filter to at least one line of pixels in an additional sub-block of the block to generate a filtered portion of the additional sub-block. The at least one line of pixels in the additional sub-block is filtered using the first filter without filtering an entirety of the additional sub-block using the first filter. The additional sub-block is adjacent to at least one of the plurality of sub-blocks. The decoder applies a second filter to the filtered plurality of sub-blocks and the filtered portion of the additional sub-block to generate a second filtered plurality of sub-blocks. Examples of the second filter include a constrained directional enhancement filter (CDEF), a loop restoration (LR) filter, a sample adaptive offset (SAO) filter, an adaptive loop filter (ALF), another filter, or a combination thereof. Applying the first filter to the at least one line of pixels in the additional sub-block and using the resulting filtered portion of the additional sub-block during application of the second filter allows the second filter to be applied to more of the block, ultimately increasing the amount of the block that can be processed during the block's processing cycle and reducing the amount of the block to be stored in a neighboring block buffer for processing during a next block's processing cycle.

The systems and methods described herein provide technical solutions to various technical problems with other decoder systems. For instance, during decoding of a specified block, some decoder systems are unable to filter certain sub-blocks of a specified block using certain filters (e.g., DB filter, SAO filter, ALF, CDEF filter, upscaler, and/or LR filter), and are therefore unable to fully decode those sub-blocks of the specified block, at least until such decoder systems move onto filtering the next block. As a result, such decoder systems end up needing to store these unfiltered sub-blocks in a neighboring block line buffer, increasing how much data such a neighboring block line buffer must be able to store, increasing an amount of write operations to the neighboring block line buffer, and increasing an amount of read operations to the neighboring block line buffer. This increases how much physical space the neighboring block line buffer requires in circuitry and increases power usage during decoding, both of which can be significant issues, especially for portable devices, always-on devices, low-powered devices, and the like. The systems and methods described herein allow for these sub-blocks of the specified block (and therefore a larger amount of the specified block) to be fully filtered and therefore fully decoded during decoding of the specified block, and remove any need to store these sub-blocks in the neighboring block line buffer. Thus, the systems and methods described herein reduce the amount of storage space needed in the neighboring block line buffer (e.g., by 44% in some examples), reduce the amount of writes to the neighboring block line buffer, reduce the amount of reads from the neighboring block line buffer, reduce the amount of power usage by the decoder system, or a combination thereof.

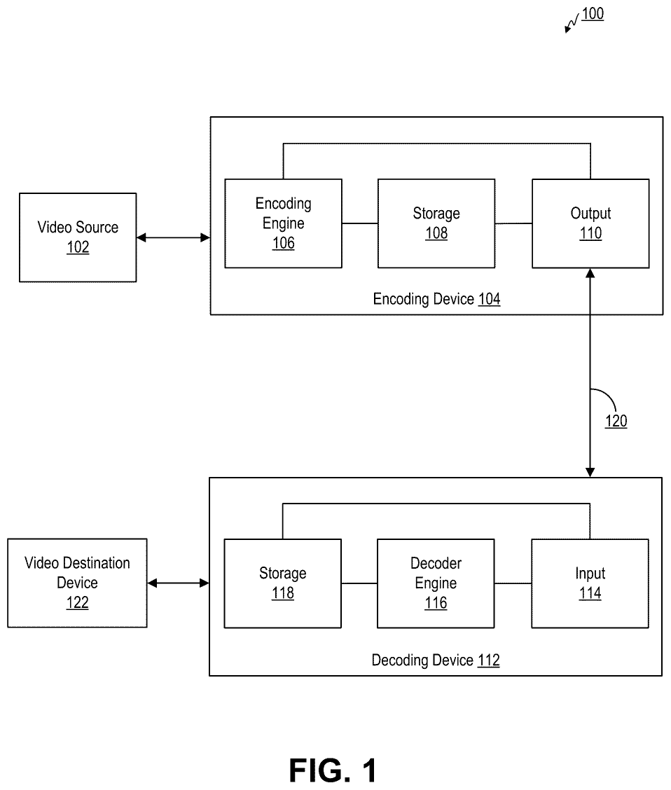

Various aspects of the application will be described with respect to the figures. FIG. 1 is a block diagram illustrating an example of a system 100 including an encoding device 104 and a decoding device 112. The encoding device 104 may be part of a source device, and the decoding device 112 may be part of a receiving device. The source device and/or the receiving device may include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the source device and the receiving device may include one or more wireless transceivers for wireless communications. The coding techniques described herein are applicable to video coding in various multimedia applications, including streaming video transmissions (e.g., over the Internet), television broadcasts or transmissions, encoding of digital video for storage on a data storage medium, decoding of digital video stored on a data storage medium, or other applications. In some examples, system 100 can support one-way or two-way video transmission to support applications such as video conferencing, video streaming, video playback, video broadcasting, gaming, and/or video telephony.

The encoding device 104 (or encoder) can be used to encode video data using a video coding standard or protocol to generate an encoded video bitstream. Examples of video coding standards include ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), including its Scalable Video Coding (SVC) and Multiview Video Coding (MVC) extensions, and High Efficiency Video Coding (HEVC) or ITU-T H.265. Various extensions to HEVC deal with multi-layer video coding exist, including the range and screen content coding extensions, 3D video coding (3D-HEVC) and multiview extensions (MV-HEVC) and scalable extension (SHVC). The HEVC and its extensions have been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG).

MPEG and ITU-T VCEG have also formed a joint exploration video team (JVET) to explore new coding tools for the next generation of video coding standard, named Versatile Video Coding (VVC). The reference software is called VVC Test Model (VTM) (or JEM (joint exploration model)). An objective of VVC is to provide a significant improvement in compression performance over the existing HEVC standard, aiding in deployment of higher-quality video services and emerging applications (e.g., such as 560° omnidirectional immersive multimedia, high-dynamic-range (HDR) video, among others). VP9, Alliance of Open Media (AOMedia) Video 1 (AV1), and Essential Video Coding (EVC) are other video codecs, formats, and/or standards for which the techniques described herein can be applied.

The techniques described herein can be applied to any of the existing video codecs (e.g., High Efficiency Video Coding (HEVC), Advanced Video Coding (AVC), or other suitable existing video codec), and/or can be an efficient coding tool for any video coding standards being developed and/or future video coding standards, such as, for example, VVC and/or other video coding standard in development or to be developed. For example, examples described herein can be performed using video codecs such as VVC, HEVC, AVC, and/or extensions thereof. However, the techniques and systems described herein may also be applicable to other codecs and/or coding formats, such as MPEG, JPEG (or other coding standard for still images), VP9, AV1, extensions thereof, or other suitable coding standards already available or not yet available or developed. Accordingly, while the techniques and systems described herein may be described with reference to a particular video coding standard, one of ordinary skill in the art will appreciate that the description should not be interpreted to apply only to that particular standard.

Many embodiments described herein provide examples using the JEM model, VVC, the HEVC standard, and/or extensions thereof. However, the techniques and systems described herein may also be applicable to other coding standards, such as AVC, MPEG, JPEG (or other coding standard for still images), extensions thereof, or other suitable coding standards already available or not yet available or developed. Accordingly, while the techniques and systems described herein may be described with reference to a particular video coding standard, one of ordinary skill in the art will appreciate that the description should not be interpreted to apply only to that particular standard.

Referring to FIG. 1, a video source 102 may provide the video data to the encoding device 104. The video source 102 may be part of the source device, or may be part of a device other than the source device. The video source 102 may include a video capture device (e.g., a video camera, a camera phone, a video phone, or the like), a video archive containing stored video, a video server or content provider providing video data, a video feed interface receiving video from a video server or content provider, a computer graphics system for generating computer graphics video data, a combination of such sources, or any other suitable video source.

The video data from the video source 102 may include one or more input pictures or frames. A picture or frame is a still image that, in some cases, is part of a video. In some examples, data from the video source 102 can be a still image that is not a part of a video. In HEVC, VVC, and other video coding specifications, a video sequence can include a series of pictures. A picture may include three sample arrays, denoted S_{L}, S_{Cb}, and S_{Cr}. S_{L} is a two-dimensional array of luma samples, S_{Cb} is a two-dimensional array of Cb chrominance samples, and S_{Cr} is a two-dimensional array of Cr chrominance samples. Chrominance samples may also be referred to herein as “chroma” samples. A pixel can refer to all three components (luma and chroma samples) for a given location in an array of a picture. In other instances, a picture may be monochrome and may only include an array of luma samples, in which case the terms pixel and sample can be used interchangeably. With respect to example techniques described herein that refer to individual samples for illustrative purposes, the same techniques can be applied to pixels (e.g., all three sample components for a given location in an array of a picture). With respect to example techniques described herein that refer to pixels (e.g., all three sample components for a given location in an array of a picture) for illustrative purposes, the same techniques can be applied to individual samples.

Two classes of Network Abstraction Layer (NAL) units exist in the HEVC standard, including video coding layer (VCL) NAL units and non-VCL NAL units. A VCL NAL unit includes one slice or slice segment (described below) of coded picture data, and a non-VCL NAL unit includes control information that relates to one or more coded pictures. In some cases, a NAL unit can be referred to as a packet. An HEVC AU includes VCL NAL units containing coded picture data and non-VCL NAL units (if any) corresponding to the coded picture data.

NAL units may contain a sequence of bits forming a coded representation of the video data (e.g., an encoded video bitstream, a CVS of a bitstream, or the like), such as coded representations of pictures in a video. The encoder engine 106 generates coded representations of pictures by partitioning each picture into multiple slices. A slice is independent of other slices so that information in the slice is coded without dependency on data from other slices within the same picture. A slice includes one or more slice segments including an independent slice segment and, if present, one or more dependent slice segments that depend on previous slice segments.

In HEVC, the slices are then partitioned into coding tree blocks (CTBs) of luma samples and chroma samples. A CTB of luma samples and one or more CTBs of chroma samples, along with syntax for the samples, are referred to as a coding tree unit (CTU). A CTU may also be referred to as a “tree block” or a “largest coding unit” (LCU). A CTU is the basic processing unit for HEVC encoding. A CTU can be split into multiple coding units (CUs) of varying sizes. A CU contains luma and chroma sample arrays that are referred to as coding blocks (CBs).

The luma and chroma CBs can be further split into prediction blocks (PBs). A PB is a block of samples of the luma component or a chroma component that uses the same motion parameters for inter-prediction or intra-block copy (IBC) prediction (when available or enabled for use). The luma PB and one or more chroma PBs, together with associated syntax, form a prediction unit (PU). For inter-prediction, a set of motion parameters (e.g., one or more motion vectors, reference indices, or the like) is signaled in the bitstream for each PU and is used for inter-prediction of the luma PB and the one or more chroma PBs. The motion parameters can also be referred to as motion information. A CB can also be partitioned into one or more transform blocks (TBs). A TB represents a square block of samples of a color component on which a residual transform (e.g., the same two-dimensional transform in some cases) is applied for coding a prediction residual signal. A transform unit (TU) represents the TBs of luma and chroma samples, and corresponding syntax elements. Transform coding is described in more detail below.

A size of a CU corresponds to a size of the coding mode and may be square in shape. For example, a size of a CU may be 8×8 samples, 16×16 samples, 32×32 samples, 64×64 samples, or any other appropriate size up to the size of the corresponding CTU. The phrase “N×N” is used herein to refer to pixel dimensions of a video block in terms of vertical and horizontal dimensions (e.g., 8 pixels×8 pixels). The pixels in a block may be arranged in rows and columns. In some embodiments, blocks may not have the same number of pixels in a horizontal direction as in a vertical direction. Syntax data associated with a CU may describe, for example, partitioning of the CU into one or more PUs. Partitioning modes may differ between whether the CU is intra-prediction mode encoded or inter-prediction mode encoded. PUs may be partitioned to be non-square in shape. Syntax data associated with a CU may also describe, for example, partitioning of the CU into one or more TUs according to a CTU. A TU can be square or non-square in shape.

According to the HEVC standard, transformations may be performed using transform units (TUs). TUs may vary for different CUs. The TUs may be sized based on the size of PUs within a given CU. The TUs may be the same size or smaller than the PUs. In some examples, residual samples corresponding to a CU may be subdivided into smaller units using a quadtree structure known as residual quad tree (RQT). Leaf nodes of the RQT may correspond to TUs. Pixel difference values associated with the TUs may be transformed to produce transform coefficients. The transform coefficients may then be quantized by the encoder engine 106.

Once the pictures of the video data are partitioned into CUs, the encoder engine 106 predicts each PU using a prediction mode. The prediction unit or prediction block is then subtracted from the original video data to get residuals (described below). For each CU, a prediction mode may be signaled inside the bitstream using syntax data. A prediction mode may include intra-prediction (or intra-picture prediction) or inter-prediction (or inter-picture prediction). Intra-prediction utilizes the correlation between spatially neighboring samples within a picture. For example, using intra-prediction, each PU is predicted from neighboring image data in the same picture using, for example, DC prediction to find an average value for the PU, planar prediction to fit a planar surface to the PU, direction prediction to extrapolate from neighboring data, or any other suitable types of prediction. Inter-prediction uses the temporal correlation between pictures in order to derive a motion-compensated prediction for a block of image samples. For example, using inter-prediction, each PU is predicted using motion compensation prediction from image data in one or more reference pictures (before or after the current picture in output order). The decision whether to code a picture area using inter-picture or intra-picture prediction may be made, for example, at the CU level.

The encoder engine 106 and decoder engine 116 (described in more detail below) may be configured to operate according to VVC. According to VVC, a video coder (such as encoder engine 106 and/or decoder engine 116) partitions a picture into a plurality of coding tree units (CTUs) (where a CTB of luma samples and one or more CTBs of chroma samples, along with syntax for the samples, are referred to as a CTU). The video coder can partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels, including a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree partition, a binary tree partition, and one or more types of triple tree partitions. A triple tree partition is a partition where a block is split into three sub-blocks. In some examples, a triple tree partition divides a block into three sub-blocks without dividing the original block through the center. The partitioning types in MTT (e.g., quadtree, binary tree, and tripe tree) may be symmetrical or asymmetrical.

In some examples, the video coder can use a single QTBT or MTT structure to represent each of the luminance and chrominance components, while in other examples, the video coder can use two or more QTBT or MTT structures, such as one QTBT or MTT structure for the luminance component and another QTBT or MTT structure for both chrominance components (or two QTBT and/or MTT structures for respective chrominance components).

The video coder can be configured to use quadtree partitioning per HEVC, QTBT partitioning, MTT partitioning, or other partitioning structures. For illustrative purposes, the description herein may refer to QTBT partitioning. However, it should be understood that the techniques of this disclosure may also be applied to video coders configured to use quadtree partitioning, or other types of partitioning as well.

In some examples, the one or more slices of a picture are assigned a slice type. Slice types include an I slice, a P slice, and a B slice. An I slice (intra-frames, independently decodable) is a slice of a picture that is only coded by intra-prediction, and therefore is independently decodable since the I slice requires only the data within the frame to predict any prediction unit or prediction block of the slice. A P slice (uni-directional predicted frames) is a slice of a picture that may be coded with intra-prediction and with uni-directional inter-prediction. Each prediction unit or prediction block within a P slice is either coded with intra-prediction or inter-prediction. When the inter-prediction applies, the prediction unit or prediction block is only predicted by one reference picture, and therefore reference samples are only from one reference region of one frame. A B slice (bi-directional predictive frames) is a slice of a picture that may be coded with intra-prediction and with inter-prediction (e.g., either bi-prediction or uni-prediction). A prediction unit or prediction block of a B slice may be bi-directionally predicted from two reference pictures, where each picture contributes one reference region and sample sets of the two reference regions are weighted (e.g., with equal weights or with different weights) to produce the prediction signal of the bi-directional predicted block. As explained above, slices of one picture are independently coded. In some cases, a picture can be coded as just one slice.

As noted above, intra-picture prediction of a picture utilizes the correlation between spatially neighboring samples within the picture. There is a plurality of intra-prediction modes (also referred to as “intra modes”). In some examples, the intra prediction of a luma block includes 35 modes, including the Planar mode, DC mode, and 33 angular modes (e.g., diagonal intra prediction modes and angular modes adjacent to the diagonal intra prediction modes). The 35 modes of the intra prediction are indexed as shown in Table 1 below. In other examples, more intra modes may be defined including prediction angles that may not already be represented by the 33 angular modes. In other examples, the prediction angles associated with the angular modes may be different from those used in HEVC.

TABLE 1
Specification of intra prediction mode and associated names

| Intra-prediction mode | Associated name |
|---|---|
| 0 | INTRA_PLANAR |
| 1 | INTRA_DC |
| 2 . . . 34 | INTRA_ANGULAR2 . . . |
| | INTRA_ANGULAR34 |

Inter-picture prediction uses the temporal correlation between pictures in order to derive a motion-compensated prediction for a block of image samples. Using a translational motion model, the position of a block in a previously decoded picture (a reference picture) is indicated by a motion vector (Δx, Δy), with Δx specifying the horizontal displacement and Δy specifying the vertical displacement of the reference block relative to the position of the current block. In some cases, a motion vector (Δx, Δy) can be in integer sample accuracy (also referred to as integer accuracy), in which case the motion vector points to the integer-pel grid (or integer-pixel sampling grid) of the reference frame. In some cases, a motion vector (Δx, Δy) can be of fractional sample accuracy (also referred to as fractional-pel accuracy or non-integer accuracy) to more accurately capture the movement of the underlying object, without being restricted to the integer-pel grid of the reference frame. Accuracy of motion vectors may be expressed by the quantization level of the motion vectors. For example, the quantization level may be integer accuracy (e.g., 1-pixel) or fractional-pel accuracy (e.g., ¼-pixel, ½-pixel, or other sub-pixel value). Interpolation is applied on reference pictures to derive the prediction signal when the corresponding motion vector has fractional sample accuracy. For example, samples available at integer positions can be filtered (e.g., using one or more interpolation filters) to estimate values at fractional positions. The previously decoded reference picture is indicated by a reference index (refIdx) to a reference picture list. The motion vectors and reference indices can be referred to as motion parameters. Two kinds of inter-picture prediction can be performed, including uni-prediction and bi-prediction.

With inter-prediction using bi-prediction, two sets of motion parameters (Δx₀, y₀,refIdx₀ and Δx₁, y₁,refIdx₁) are used to generate two motion compensated predictions (from the same reference picture or possibly from different reference pictures). For example, with bi-prediction, each prediction block uses two motion compensated prediction signals, and generates B prediction units. The two motion compensated predictions are then combined to get the final motion compensated prediction. For example, the two motion compensated predictions can be combined by averaging. In another example, weighted prediction can be used, in which case different weights can be applied to each motion compensated prediction. The reference pictures that can be used in bi-prediction are stored in two separate lists, denoted as list 0 and list 1. Motion parameters can be derived at the encoder using a motion estimation process.

With inter-prediction using uni-prediction, one set of motion parameters (Δx₀, y₀,refIdx₀) is used to generate a motion compensated prediction from a reference picture. For example, with uni-prediction, each prediction block uses at most one motion compensated prediction signal, and generates P prediction units.

A PU may include the data (e.g., motion parameters or other suitable data) related to the prediction process. For example, when the PU is encoded using intra-prediction, the PU may include data describing an intra-prediction mode for the PU. As another example, when the PU is encoded using inter-prediction, the PU may include data defining a motion vector for the PU. The data defining the motion vector for a PU may describe, for example, a horizontal component of the motion vector (Δx), a vertical component of the motion vector (Δy), a resolution for the motion vector (e.g., integer precision, one-quarter pixel precision or one-eighth pixel precision), a reference picture to which the motion vector points, a reference index, a reference picture list (e.g., List 0, List 1, or List C) for the motion vector, or any combination thereof.

After performing prediction using intra- and/or inter-prediction, the encoding device 104 can perform transformation and quantization. For example, following prediction, the encoder engine 106 may calculate residual values corresponding to the PU. Residual values may comprise pixel difference values between the current block of pixels being coded (the PU) and the prediction block used to predict the current block (e.g., the predicted version of the current block). For example, after generating a prediction block (e.g., issuing inter-prediction or intra-prediction), the encoder engine 106 can generate a residual block by subtracting the prediction block produced by a prediction unit from the current block. The residual block includes a set of pixel difference values that quantify differences between pixel values of the current block and pixel values of the prediction block. In some examples, the residual block may be represented in a two-dimensional block format (e.g., a two-dimensional matrix or array of pixel values). In such examples, the residual block is a two-dimensional representation of the pixel values.

Any residual data that may be remaining after prediction is performed is transformed using a block transform, which may be based on discrete cosine transform, discrete sine transform, an integer transform, a wavelet transform, other suitable transform function, or any combination thereof. In some cases, one or more block transforms (e.g., sizes 32×32, 16×16, 8×8, 4×4, or other suitable size) may be applied to residual data in each CU. In some embodiments, a TU may be used for the transform and quantization processes implemented by the encoder engine 106. A given CU having one or more PUs may also include one or more TUs. As described in further detail below, the residual values may be transformed into transform coefficients using the block transforms, and then may be quantized and scanned using TUs to produce serialized transform coefficients for entropy coding.

In some embodiments following intra-predictive or inter-predictive coding using PUs of a CU, the encoder engine 106 may calculate residual data for the TUs of the CU. The PUs may comprise pixel data in the spatial domain (or pixel domain). The TUs may comprise coefficients in the transform domain following application of a block transform. As previously noted, the residual data may correspond to pixel difference values between pixels of the unencoded picture and prediction values corresponding to the PUs. Encoder engine 106 may form the TUs including the residual data for the CU, and may then transform the TUs to produce transform coefficients for the CU.

The encoder engine 106 may perform quantization of the transform coefficients. Quantization provides further compression by quantizing the transform coefficients to reduce the amount of data used to represent the coefficients. For example, quantization may reduce the bit depth associated with some or all of the coefficients. In one example, a coefficient with an n-bit value may be rounded down to an m-bit value during quantization, with n being greater than m.

Once quantization is performed, the coded video bitstream includes quantized transform coefficients, prediction information (e.g., prediction modes, motion vectors, block vectors, or the like), partitioning information, and any other suitable data, such as other syntax data. The different elements of the coded video bitstream may then be entropy encoded by the encoder engine 106. In some examples, the encoder engine 106 may utilize a predefined scan order to scan the quantized transform coefficients to produce a serialized vector that can be entropy encoded. In some examples, encoder engine 106 may perform an adaptive scan. After scanning the quantized transform coefficients to form a vector (e.g., a one-dimensional vector), the encoder engine 106 may entropy encode the vector. For example, the encoder engine 106 may use context adaptive variable length coding, context adaptive binary arithmetic coding, syntax-based context-adaptive binary arithmetic coding, probability interval partitioning entropy coding, or another suitable entropy encoding technique.

As previously described, an HEVC bitstream includes a group of NAL units, including VCL NAL units and non-VCL NAL units. VCL NAL units include coded picture data forming a coded video bitstream. For example, a sequence of bits forming the coded video bitstream is present in VCL NAL units. Non-VCL NAL units may contain parameter sets with high-level information relating to the encoded video bitstream, in addition to other information. For example, a parameter set may include a video parameter set (VPS), a sequence parameter set (SPS), and a picture parameter set (PPS). Examples of goals of the parameter sets include bit rate efficiency, error resiliency, and providing systems layer interfaces. Each slice references a single active PPS, SPS, and VPS to access information that the decoding device 112 may use for decoding the slice. An identifier (ID) may be coded for each parameter set, including a VPS ID, an SPS ID, and a PPS ID. An SPS includes an SPS ID and a VPS ID. A PPS includes a PPS ID and an SPS ID. Each slice header includes a PPS ID. Using the IDs, active parameter sets can be identified for a given slice.

A PPS includes information that applies to all slices in a given picture. Because of this, all slices in a picture refer to the same PPS. Slices in different pictures may also refer to the same PPS. An SPS includes information that applies to all pictures in a same coded video sequence (CVS) or bitstream. As previously described, a coded video sequence is a series of access units (AUs) that starts with a random access point picture (e.g., an instantaneous decode reference (IDR) picture or broken link access (BLA) picture, or other appropriate random access point picture) in the base layer and with certain properties (described above) up to and not including a next AU that has a random access point picture in the base layer and with certain properties (or the end of the bitstream). The information in an SPS may not change from picture to picture within a coded video sequence. Pictures in a coded video sequence may use the same SPS. The VPS includes information that applies to all layers within a coded video sequence or bitstream. The VPS includes a syntax structure with syntax elements that apply to entire coded video sequences. In some embodiments, the VPS, SPS, or PPS may be transmitted in-band with the encoded bitstream. In some embodiments, the VPS, SPS, or PPS may be transmitted out-of-band in a separate transmission than the NAL units containing coded video data.

A video bitstream can also include Supplemental Enhancement Information (SEI) messages. For example, an SEI NAL unit can be part of the video bitstream. In some cases, an SEI message can contain information that is not needed by the decoding process. For example, the information in an SEI message may not be essential for the decoder to decode the video pictures of the bitstream, but the decoder can be use the information to improve the display or processing of the pictures (e.g., the decoded output). The information in an SEI message can be embedded metadata. In one illustrative example, the information in an SEI message could be used by decoder-side entities to improve the viewability of the content. In some instances, certain application standards may mandate the presence of such SEI messages in the bitstream so that the improvement in quality can be brought to all devices that conform to the application standard (e.g., the carriage of the frame-packing SEI message for frame-compatible plano-stereoscopic 3DTV video format, where the SEI message is carried for every frame of the video, handling of a recovery point SEI message, use of pan-scan scan rectangle SEI message in DVB, in addition to many other examples).

The output 110 of the encoding device 104 may send the NAL units making up the encoded video bitstream data over the communications link 120 to the decoding device 112 of the receiving device. The input 114 of the decoding device 112 may receive the NAL units. The communications link 120 may include a channel provided by a wireless network, a wired network, or a combination of a wired and wireless network. A wireless network may include any wireless interface or combination of wireless interfaces and may include any suitable wireless network (e.g., the Internet or other wide area network, a packet-based network, WiFi™, radio frequency (RF), UWB, WiFi-Direct, cellular, Long-Term Evolution (LTE), WiMax™, or the like). A wired network may include any wired interface (e.g., fiber, ethernet, powerline ethernet, ethernet over coaxial cable, digital signal line (DSL), or the like). The wired and/or wireless networks may be implemented using various equipment, such as base stations, routers, access points, bridges, gateways, switches, or the like. The encoded video bitstream data may be modulated according to a communication standard, such as a wireless communication protocol, and transmitted to the receiving device.

In some examples, the encoding device 104 may store encoded video bitstream data in storage 108. The output 110 may retrieve the encoded video bitstream data from the encoder engine 106 or from the storage 108. Storage 108 may include any of a variety of distributed or locally accessed data storage media. For example, the storage 108 may include a hard drive, a storage disc, flash memory, volatile or non-volatile memory, or any other suitable digital storage media for storing encoded video data. The storage 108 can also include a decoded picture buffer (DPB) for storing reference pictures for use in inter-prediction. In a further example, the storage 108 can correspond to a file server or another intermediate storage device that may store the encoded video generated by the source device. In such cases, the receiving device including the decoding device 112 can access stored video data from the storage device via streaming or download. The file server may be any type of server capable of storing encoded video data and transmitting that encoded video data to the receiving device. Example file servers include a web server (e.g., for a website), an FTP server, network attached storage (NAS) devices, or a local disk drive. The receiving device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage 108 may be a streaming transmission, a download transmission, or a combination thereof.

The input 114 of the decoding device 112 receives the encoded video bitstream data and may provide the video bitstream data to the decoder engine 116, or to storage 118 for later use by the decoder engine 116. For example, the storage 118 can include a DPB for storing reference pictures for use in inter-prediction. The receiving device including the decoding device 112 can receive the encoded video data to be decoded via the storage 108. The encoded video data may be modulated according to a communication standard, such as a wireless communication protocol, and transmitted to the receiving device. The communication medium for transmitted the encoded video data can comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device to the receiving device.

The decoder engine 116 may decode the encoded video bitstream data by entropy decoding (e.g., using an entropy decoder) and extracting the elements of one or more coded video sequences making up the encoded video data. The decoder engine 116 may then rescale and perform an inverse transform on the encoded video bitstream data. Residual data is then passed to a prediction stage of the decoder engine 116. The decoder engine 116 then predicts a block of pixels (e.g., a PU). In some examples, the prediction is added to the output of the inverse transform (the residual data).

The decoding device 112 may output the decoded video to a video destination device 122, which may include a display or other output device for displaying the decoded video data to a consumer of the content. In some aspects, the video destination device 122 may be part of the receiving device that includes the decoding device 112. In some aspects, the video destination device 122 may be part of a separate device other than the receiving device.

In some embodiments, the video encoding device 104 and/or the video decoding device 112 may be integrated with an audio encoding device and audio decoding device, respectively. The video encoding device 104 and/or the video decoding device 112 may also include other hardware or software that is necessary to implement the coding techniques described above, such as one or more microprocessors, digital signal processors (DSPs), application specific integrated circuits (ASICs), field programmable gate arrays (FPGAs), discrete logic, software, hardware, firmware or any combinations thereof. The video encoding device 104 and the video decoding device 112 may be integrated as part of a combined encoder/decoder (codec) in a respective device.

The example system shown in FIG. 1 is one illustrative example that can be used herein. Techniques for processing video data using the techniques described herein can be performed by any digital video encoding and/or decoding device. Although generally the techniques of this disclosure are performed by a video encoding device or a video decoding device, the techniques may also be performed by a combined video encoder-decoder, typically referred to as a “CODEC.” Moreover, the techniques of this disclosure may also be performed by a video preprocessor. The source device and the receiving device are merely examples of such coding devices in which the source device generates coded video data for transmission to the receiving device. In some examples, the source and receiving devices may operate in a substantially symmetrical manner such that each of the devices include video encoding and decoding components. Hence, example systems may support one-way or two-way video transmission between video devices, e.g., for video streaming, video playback, video broadcasting, or video telephony.

Extensions to the HEVC standard include the Multiview Video Coding extension, referred to as MV-HEVC, and the Scalable Video Coding extension, referred to as SHVC. The MV-HEVC and SHVC extensions share the concept of layered coding, with different layers being included in the encoded video bitstream. Each layer in a coded video sequence is addressed by a unique layer identifier (ID). A layer ID may be present in a header of a NAL unit to identify a layer with which the NAL unit is associated. In MV-HEVC, different layers can represent different views of the same scene in the video bitstream. In SHVC, different scalable layers are provided that represent the video bitstream in different spatial resolutions (or picture resolution) or in different reconstruction fidelities. The scalable layers may include a base layer (with layer ID=0) and one or more enhancement layers (with layer IDs=1, 2, . . . n). The base layer may conform to a profile of the first version of HEVC, and represents the lowest available layer in a bitstream. The enhancement layers have increased spatial resolution, temporal resolution or frame rate, and/or reconstruction fidelity (or quality) as compared to the base layer. The enhancement layers are hierarchically organized and may (or may not) depend on lower layers. In some examples, the different layers may be coded using a single standard codec (e.g., all layers are encoded using HEVC, SHVC, or other coding standard). In some examples, different layers may be coded using a multi-standard codec. For example, a base layer may be coded using AVC, while one or more enhancement layers may be coded using SHVC and/or MV-HEVC extensions to the HEVC standard.

In general, a layer includes a set of VCL NAL units and a corresponding set of non-VCL NAL units. The NAL units are assigned a particular layer ID value. Layers can be hierarchical in the sense that a layer may depend on a lower layer. A layer set refers to a set of layers represented within a bitstream that are self-contained, meaning that the layers within a layer set can depend on other layers in the layer set in the decoding process, but do not depend on any other layers for decoding. Accordingly, the layers in a layer set can form an independent bitstream that can represent video content. The set of layers in a layer set may be obtained from another bitstream by operation of a sub-bitstream extraction process. A layer set may correspond to the set of layers that is to be decoded when a decoder wants to operate according to certain parameters.

As described above, for each block, a set of motion information (also referred to herein as motion parameters) can be available. A set of motion information contains motion information for forward and backward prediction directions. The forward and backward prediction directions are two prediction directions of a bi-directional prediction mode, in which case the terms “forward” and “backward” do not necessarily have a geometrical meaning. Instead, “forward” and “backward” correspond to reference picture list 0 (RefPicList0 or L0) and reference picture list 1 (RefPicList1 or L1) of a current picture. In some examples, when only one reference picture list is available for a picture or slice, only RefPicList0 is available and the motion information of each block of a slice is always forward.

In some cases, a motion vector together with its reference index is used in coding processes (e.g., motion compensation). Such a motion vector with the associated reference index is denoted as a uni-predictive set of motion information. For each prediction direction, the motion information can contain a reference index and a motion vector. In some cases, for simplicity, a motion vector itself may be referred in a way that it is assumed that it has an associated reference index. A reference index is used to identify a reference picture in the current reference picture list (RefPicList0 or RefPicList1). A motion vector has a horizontal and a vertical component that provide an offset from the coordinate position in the current picture to the coordinates in the reference picture identified by the reference index. For example, a reference index can indicate a particular reference picture that should be used for a block in a current picture, and the motion vector can indicate where in the reference picture the best-matched block (the block that best matches the current block) is in the reference picture.

A picture order count (POC) can be used in video coding standards to identify a display order of a picture. Although there are cases for which two pictures within one coded video sequence may have the same POC value, it typically does not happen within a coded video sequence. When multiple coded video sequences are present in a bitstream, pictures with a same value of POC may be closer to each other in terms of decoding order. POC values of pictures can be used for reference picture list construction, derivation of reference picture set as in HEVC, and motion vector scaling.

In H.264/AVC, each inter macroblock (MB) may be partitioned in four different ways, including: one 16×16 MB partition; two 16×8 MB partitions; two 8×16 MB partitions; and four 8×8 MB partitions. Different MB partitions in one MB may have different reference index values for each direction (RefPicList0 or RefPicList1). In some cases, when an MB is not partitioned into four 8×8 MB partitions, it can have only one motion vector for each MB partition in each direction. In some cases, when an MB is partitioned into four 8×8 MB partitions, each 8×8 MB partition can be further partitioned into sub-blocks, in which case each sub-block can have a different motion vector in each direction. In some examples, there are four different ways to get sub-blocks from an 8×8 MB partition, including: one 8×8 sub-block; two 8×4 sub-blocks; two 4×8 sub-blocks; and four 4×4 sub-blocks. Each sub-block can have a different motion vector in each direction. Therefore, a motion vector is present in a level equal to higher than sub-block.

In AVC, a temporal direct mode can be enabled at either the MB level or the MB partition level for skip and/or direct mode in B slices. For each MB partition, the motion vectors of the block co-located with the current MB partition in the RefPicList1 [0] of the current block are used to derive the motion vectors. Each motion vector in the co-located block is scaled based on POC distances.

A spatial direct mode can also be performed in AVC. For example, in AVC, a direct mode can also predict motion information from the spatial neighbors.

In HEVC, the largest coding unit in a slice is called a coding tree block (CTB). A CTB contains a quad-tree, the nodes of which are coding units. The size of a CTB can range from 16×16 to 64×64 in the HEVC main profile. In some cases, 8×8 CTB sizes can be supported. A coding unit (CU) could be the same size of a CTB and as small as 8×8. In some cases, each coding unit is coded with one mode. When a CU is inter-coded, the CU may be further partitioned into 2 or 4 prediction units (PUs), or may become just one PU when further partition does not apply. When two PUs are present in one CU, they can be half size rectangles or two rectangles with ¼ or ¾ size of the CU.

When the CU is inter-coded, one set of motion information is present for each PU. In addition, each PU is coded with a unique inter-prediction mode to derive the set of motion information.

For motion prediction in HEVC, there are two inter-prediction modes, including merge mode and advanced motion vector prediction (AMVP) mode for a prediction unit (PU). Skip is considered as a special case of merge. In either AMVP or merge mode, a motion vector (MV) candidate list is maintained for multiple motion vector predictors. The motion vector(s), as well as reference indices in the merge mode, of the current PU are generated by taking one candidate from the MV candidate list. In some examples, as described below, one or more stored local illumination compensation (LIC) flags can be included along with stored motion vectors in a MV candidate list.

In examples where a MV candidate list is used for motion prediction (and where applicable, illumination compensation) of a block, the MV candidate list may be constructed by the encoding device and the decoding device separately. For instance, the MV candidate list can be generated by an encoding device when encoding a block, and can be generated by a decoding device when decoding the block. Information related to motion information candidates in the MV candidate list (e.g. information related to one or more motion vectors, information related to one or more LIC flags which can be stored in the MV candidate list in some cases, and/or other information), can be signaled between the encoding device and the decoding device. For example, in the merge mode, index values to the stored motion information candidates can be signaled from an encoding device to a decoding device (e.g., in a syntax structure, such as the picture parameter set (PPS), sequence parameter set (SPS), video parameter set (VPS), a slice header, a supplemental enhancement information (SEI) message sent in or separately from the video bitstream, and/or other signaling). The decoding device can construct a MV candidate list and use the signaled references or indexes to obtain one or more motion information candidates from the constructed MV candidate list to use for motion compensation prediction. For example, the decoding device 112 may construct a MV candidate list and use a motion vector (and in some cases an LIC flag) from an indexed location for motion prediction of the block. In the case of AMVP mode, in addition to the references or indexes, differences or residual values may also be signaled as deltas. For example, for the AMVP mode, the decoding device can construct one or more MV candidate lists and apply the delta values to one or more motion information candidates obtained using the signaled index values in performing motion compensation prediction of the block.

In some examples, the MV candidate list contains up to five candidates for the merge mode and two candidates for the AMVP mode. In other examples, different numbers of candidates can be included in a MV candidate list for merge mode and/or AMVP mode. A merge candidate may contain a set of motion information. For example, a set of motion information can include motion vectors corresponding to both reference picture lists (list 0 and list 1) and the reference indices. If a merge candidate is identified by a merge index, the reference pictures are used for the prediction of the current blocks, as well as the associated motion vectors are determined. However, under AMVP mode, for each potential prediction direction from either list 0 or list 1, a reference index needs to be explicitly signaled, together with an MVP index to the MV candidate list since the AMVP candidate contains only a motion vector. In AMVP mode, the predicted motion vectors can be further refined.

As can be seen above, a merge candidate corresponds to a full set of motion information, while an AMVP candidate contains just one motion vector for a specific prediction direction and reference index. The candidates for both modes are derived similarly from the same spatial and temporal neighboring blocks.

In some examples, merge mode allows an inter-predicted PU to inherit the same motion vector or vectors, prediction direction, and reference picture index or indices from an inter-predicted PU that includes a motion data position selected from a group of spatially neighboring motion data positions and one of two temporally co-located motion data positions. For AMVP mode, motion vector or vectors of a PU can be predicatively coded relative to one or more motion vector predictors (MVPs) from an AMVP candidate list constructed by an encoder and/or a decoder. In some instances, for single direction inter-prediction of a PU, the encoder and/or decoder can generate a single AMVP candidate list. In some instances, for bi-directional prediction of a PU, the encoder and/or decoder can generate two AMVP candidate lists, one using motion data of spatial and temporal neighboring PUs from the forward prediction direction and one using motion data of spatial and temporal neighboring PUs from the backward prediction direction.

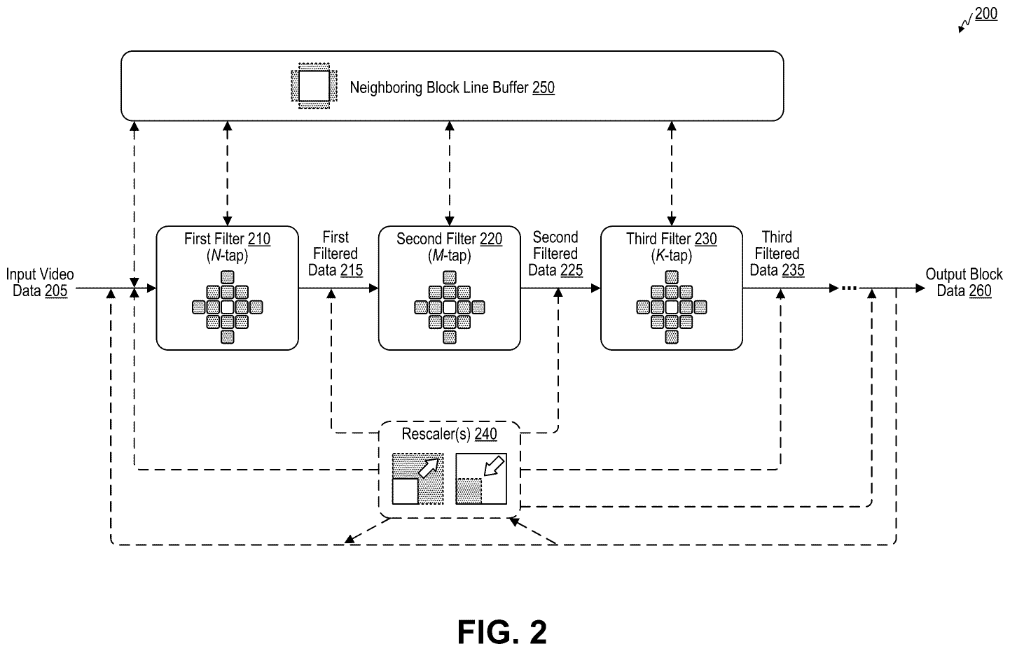

FIG. 2 is a block diagram illustrating a decoder system 200 that includes and applies a first filter 210, a second filter 220, and a third filter 230. The decoder system 200 may be an example of the decoding device 112, the decoder engine 116, decoder system 300, the decoder system 400, the decoder system 600, the decoder system 700, the codec system that performs the codec process 800, the computing system 900, or a combination thereof.

The decoder system 200 receives input video data 205. The input video data 205 may be encoded using an encoder, such as the encoding device 104 and/or the encoding engine 106. The encoded video data 270 may include, for example, the encoded video bitstream data (e.g., the NAL units) discussed with respect to the output 110 of the encoding device 104 and/or the input 114 of the decoding device 112. In some examples, the input video data 205 includes at least a portion of a first block of the input video data 205 and/or at least a portion of a neighboring block of the input video data 205 adjacent to the first block. The term “first block” may refer to a block that the decoder system 200 is currently filtering as the decoder system 200 filters video data block-by-block according to an order (e.g., horizontal raster order, vertical raster order, or another order). The first block can be referred to as the current block, the primary block, the block, or another term. The first filtered data 215 can include filtered variant(s) (e.g., filtered using the first filter 210) of both pixel data from the first block as well as pixel data from the neighboring block. The decoder system 200 filters the input video data 205 using the first filter 210 to generate first filtered data 215. The decoder system 200 filters the first filtered data 215 using the second filter 220 to generate second filtered data 225. The second filtered data 225 can include filtered variant(s) (e.g., filtered using the second filter 220 and/or the first filter 210) of both pixel data from the first block as well as pixel data from the neighboring block. The decoder system 200 filters the second filtered data 225 using the third filter 230 to generate third filtered data 235. The third filtered data 235 can include filtered variant(s) (e.g., filtered using the third filter 230, the second filter 220, and/or the first filter 210) of both pixel data from the first block as well as pixel data from the neighboring block. In some examples, the decoder system 200 may include more filters in addition to the first filter 210, the second filter 220, and the third filter 230, as represented by the ellipsis between the third filtered data 235 and the output block data 260.

In such examples, the last of the additional filters can generate the output block data 260. In some examples, the third filter 230 is the last filter in the decoder system 200, and the third filtered data 235 is the output block data 260. In some examples, the output block data 260 is an output of a first cycle of filtering, and the output block data 260 is loops back around to be filtered again, starting from application of the first filter 210, then the second filter 220 and third filter 230 and/or any other filters, and so forth, for one or more additional cycles of filtering. In some examples, the output block data 260 represents processed video data to be stored in memory, displayed on a display, sent to a recipient device, otherwise output, or a combination thereof. In some examples, the decoder system 200 may omit the third filter 230, for instance only including the first filter 210 and the second filter 220.

The first filter 210 is an N-tap filter, meaning that to filter a specific pixel, the first filter 210 uses pixel information from that specific pixel as well as pixel information from (N−1)/2 pixels to the left of the specific pixel, pixel information from (N−1)/2 pixels to the right of the specific pixel, pixel information from (N−1)/2 pixels to above of the specific pixel, pixel information from (N−1)/2 pixels to below the specific pixel, and/or pixel information from pixels diagonal from the specific pixel (e.g., according to a diamond pattern). For instance, a diamond pattern of shaded pixels around a white pixel is illustrated in the boxes representing the first filter 210, the second filter 220, and the third filter 230. This diamond pattern shows a 5-tap filter, with the white pixel being the specific pixel being filtered while the shaded pixels represent the pixels whose information is used to filter the specific pixel. The second filter 220 is an M-tap filter, similarly meaning that to filter a specific pixel, the second filter 220 uses pixel information from that specific pixel as well as pixel information from (M−1)/2 pixels to the left of the specific pixel, to the right of the specific pixel, above the specific pixel, and below the specific pixel. The third filter 230 is a K-tap filter, similarly meaning that to filter a specific pixel, the third filter 230 uses pixel information from that specific pixel as well as pixel information from (K−1)/2 pixels to the left of the specific pixel, to the right of the specific pixel, above the specific pixel, and below the specific pixel. In some examples, N, M, and/or K are distinct values. In some examples, to or more of N, M, and/or K are equal. For instance, while the diamond pattern graphics illustrated in the boxes representing the three illustrated filters (e.g., the first filter 210, the second filter 220, and the third filter 230) of the decoder system 200 of FIG. 2 all illustrate a 5-tap filter, it should be understood that N, M, and/or K can each be less than 5, equal to 5, or more than 5. In some examples, N≥M. In some examples, N≥K.

In some examples, the input video data 205 may be at least partially decoded and/or processed by the decoder system 200 (and/or another aspect of the decoding device 112 and/or the decoder engine 116) by the time the decoder system 200 inputs the input video data 205 into the first filter 210. For instance, the decoder system 200 (and/or another aspect of the decoding device 112 and/or the decoder engine 116) can have already been processed using an inverse discrete cosine transform (IDCT). The input video data 205 includes pixel data from a first block of a video frame, as well as pixel data from a neighboring block of the video frame. The neighboring block can be located adjacent to the first block within the context of the video frame. In some examples, the neighboring block is located to the left of the first block within the context of the video frame. In some examples, the neighboring block is located above the first block within the context of the video frame. In some examples, the neighboring block is located to the right of the first block within the context of the video frame. In some examples, the neighboring block is located below the first block within the context of the video frame. In some examples, the first block and/or the neighboring block can be superblocks, macroblocks, and/or tiles.

In some examples, the amount of neighboring block data included in the input video data 205 (and/or stored in the neighboring line buffer 250) can depend on the value(s) of N, M, and/or K for the filters (e.g., the first filter 210, the second filter 220, and the third filter 230) of the decoder system 200 of FIG. 2. In an illustrative example, to filter the pixels at the leftmost edge of a block, the filters of the decoder system 200 may need to use pixel information from the right-hand side of the neighboring block to the left of the first block, according to the values of N, M, and/or K. For instance, to filter the pixels at the leftmost edge of a block, the first filter 210 may need to use pixel information from the (N−1)/2 rightmost columns of pixels in the neighboring block to the left of the first block. Similarly, the second filter 220 may need to use pixel information from the (M−1)/2 rightmost columns of pixels in the neighboring block to the left of the first block. Similarly, the third filter 230 may need to use pixel information from the (K−1)/2 rightmost columns of pixels in the neighboring block to the left of the first block. Thus, the input video data 205 includes at least pixel information from (max (N,M,K)−1)/2 line(s) (e.g., rows and/or columns) of pixels from the neighboring block, the line(s) of pixels in the neighboring block being the line(s) of pixels closest to the shared edge with the first block being filtered.

In some examples, the decoder system 200 includes one or more rescaler(s) 240, which may include one or more upscaler(s), upsampler(s), downscaler(s), downsampler(s), resampler(s), or a combination thereof. For instance, certain filters can be applied to downscaled or downsampled versions of the video data (filtered or otherwise), to upscaled or upsampled versions of the video data (filtered or otherwise), or a combination thereof. In some examples, or more of the filters (e.g., the first filter 210, the second filter 220, and/or the third filter 230) can be one of the rescaler(s) 240. In some examples, one or more of the rescaler(s) 240 can be applied to output block data 260 on the way from one cycle to the next (e.g., from the last filter back to the first filter 210). The rescaler(s) 240 can use any rescaling or resampling techniques, such as rescaling, resampling, resizing, nearest-neighbor interpolation, bilinear interpolation, bicubic interpolation, sinc resampling, Lanczos resampling, box sampling, mipmapping, interpolation based on Fourier transform(s), edge-directed interpolation, high-quality scaling (HQX), vectorization, super-resolution, deep convolutional neural network(s), or a combination thereof. In some examples the rescaler(s) 240 performs horizontal rescaling without vertical rescaling. In some examples the rescaler(s) 240 performs vertical rescaling without horizontal rescaling. In some examples, the rescaler(s) 240 performs both horizontal rescaling and vertical rescaling.

Examples of the filters (e.g., the first filter 210, the second filter 220, and/or the third filter 230) of the decoder system 200 include a deblocking (DB) filter (e.g., which is a 13-tap filter and can include a horizontal DB filter and/or a vertical DB filter), a sample adaptive offset (SAO) filter (e.g., which is a 3-tap filter), an adaptive loop filter (ALF) (e.g., which includes a 7-tap luma ALF and/or a 5-tap chroma ALF), a constrained directional enhancement filter (CDEF) (e.g., which is a 5-tap filter), a loop restoration (LR) filter (e.g., which is a 7-tap filter), another filter, or a combination thereof. In some examples, a DB filter can be a 7-tap filter, for instance under h265.

In some examples, the decoder system 200 does not filter the entirety of the block. For instance, in some codecs and/or formats, the input video data 205 to the decoder system 200 includes a first block and a small portion of one or two neighboring block (e.g., a few lines as needed to provide neighboring pixel data for filters). Which neighboring block(s) are chosen to use pixel data from can depend on the decoding order (e.g., horizontal raster order or vertical raster order). For instance, in some examples, the left neighboring block to the left of the first block is used, and/or the top neighboring block above the first block is used. In examples where decoding of blocks is performed in a raster order (e.g., horizontal raster order or vertical raster order), the decoder system 200 may already have filtered data for one or both of the left neighboring block and the top neighboring block, allowing for a reduction in redundant filtering work. However, in cases where the input video data 205 only includes neighboring block data from the left neighboring block and/or the top neighboring block, the filters of the decoder may not have sufficient data to filter the pixels along the right edge and/or the bottom edge of the first block, because the input video data 205 lacks neighboring block data from the right neighboring block (to the right of the first block) and the bottom neighboring block (below the first block). In such examples, the decoder system 200 can delay filtering of the pixels along the right edge and/or the bottom edge of the first block until the decoder system 200 moves on to filtering the next block (e.g., the right neighboring block or the bottom neighboring block) in the order (e.g., horizontal raster order or vertical raster order) after the first block. The decoder system 200 can store pixel data from the first block (filtered and/or unfiltered) in a neighboring block line buffer (e.g., the neighboring block line buffer 250) to be used to filter the next block in the order (which may be referred to as the second block or the next block) as well as to filter the data from the first block that wasn't filtered during the block decoding cycle for the first block (e.g., as stored in the neighboring block line buffer 250).

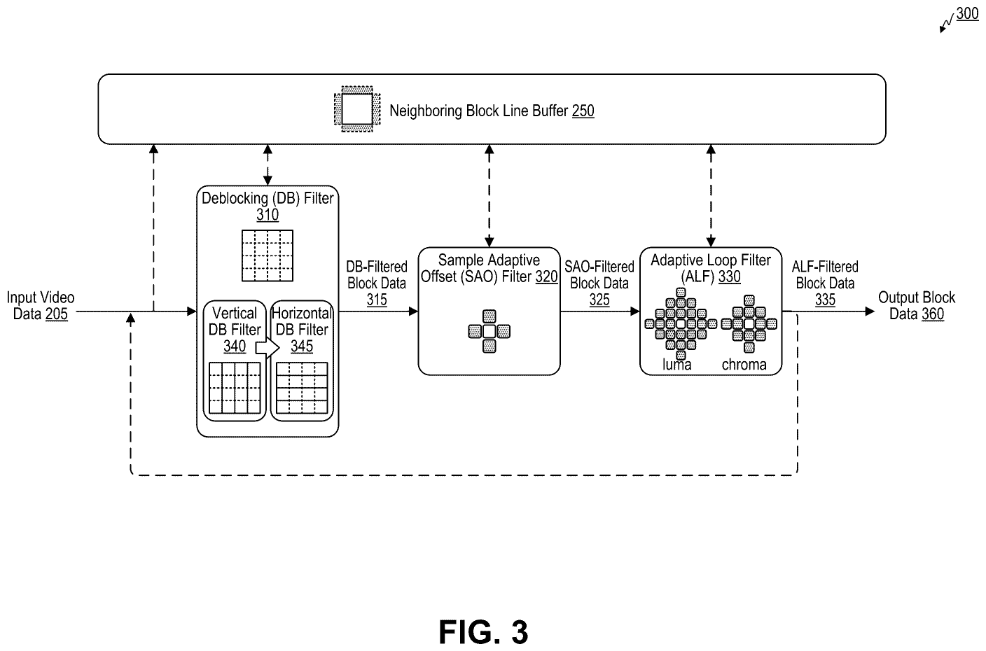

FIG. 3 is a block diagram illustrating a decoder system 300 in which the first filter 210 is a deblocking (DB) filter 310, the second filter 220 is a sample adaptive offset (SAO) filter 320, and the third filter 230 is an adaptive loop filter (ALF) 330. The decoder system 300 is an example of the decoder system 200. In some examples, the decoder system 300 may be an example of the decoding device 112, the decoder engine 116, decoder system 200, the decoder system 600, the decoder system 700, the codec system that performs the codec process 800, the computing system 900, or a combination thereof.

The decoder system 200 uses the DB filter 310 to filter the input video data 205 to remove bordering artifacts at the edges of coded blocks and/or sub-blocks (e.g., boundary discontinuities), for example by smoothing block edge artifacts away. In some examples, to filter the input video data 205 using the DB filter 310, the decoder system 200 can analyze the input video data 205 using one or more heuristic-based analysis to determine differences between bordering artifacts and legitimate details in video data at block edges, and control conditional application of smoothing at block edges. In some examples, the heuristic-based analysis can consider changes in luminosity at and/or across block edges, changes in specific color channels (e.g., red, green, and/or blue) at and/or across block edges, whether the block edges are internal to a larger block (e.g., superblock, macroblock, and/or tile) or at one or more edges of the larger block, any coded residuals present for the block, any block motion data (e.g., motion vectors) associated with the block, any block motion compensation data associated with the block, or a combination thereof. A graphic representing the DB filter 310 in FIG. 2 illustrates block edges using dotted lines, to represent smoothing of visual artifacts at such block edges to make the block edges less prominent when the video frame is viewed as a whole.

By filtering the input video data 205, the DB filter 310 generates DB-filtered block data 315 corresponding to the first block, and in some examples DB-filtered variant(s) of the neighboring block data from the neighboring block. The DB-filtered block data 315 is an example of the first filtered data 215. In some examples, the first filtered data 215 can also include filtered variant(s) of the neighboring block data from the neighboring block filtered using the first filter 210, which in the context of the decoder system 300 means that the DB-filtered block data 315 can include the DB-filtered variant(s) of the neighboring block data. The decoder system 300 passes the DB-filtered block data 315 from the DB filter 310 to the second filter 220, which in the decoder system 300 is the SAO filter 320. The SAO filter 320 filters the DB-filtered block data 315 to generate SAO-filtered block data 325. The SAO-filtered block data 325 is an example of the second filtered data 225. The decoder system 300 passes to the SAO-filtered block data 325 to the to the third filter 230, which in the decoder system 300 is the ALF 330. The ALF 330 filters the SAO-filtered block data 325 to generate ALF-filtered block data 335.

In some examples, the decoder system 200 passes a portion of the DB-filtered block data 315 that corresponds to the neighboring block from the DB filter 310 to the neighboring block line buffer 250. In some examples, the decoder system 200 upscales or downscales (e.g., using rescaler(s) 240) at least the portion of the DB-filtered block data 315 that corresponds to the neighboring block before storing the portion of the DB-filtered block data 315 that corresponds to the neighboring block in the neighboring block line buffer 250. This way, any filter that expects an upscaled or downscaled variant of the DB-filtered neighboring block data can retrieve the upscaled or downscaled variant of the DB-filtered neighboring block data from the neighboring block line buffer 250. In some examples, the decoder system 200 stores the DB-filtered neighboring block data in the neighboring block line buffer 250 without upscaling or downscaling the DB-filtered neighboring block data, and rescaler(s) 240 can upscale or downscale the DB-filtered neighboring block data for any filter that expects an upscaled or downscaled variant of the DB-filtered neighboring block data as needed after retrieval of the DB-filtered neighboring block data from the neighboring block line buffer 250.

In some examples, the DB filter 310 includes a vertical DB filter 340 and a horizontal DB filter 345. To apply the DB filter 310 to the input video data 205, the decoder system 200 can apply the vertical DB filter 340 to the input video data 205, then apply the horizontal DB filter 345 to the input video data 205 after the vertical DB filter 340 has already been applied, or vice versa. In some examples, the DB filter 310 (e.g., the vertical DB filter 340 and/or the horizontal DB filter 345) uses 13-tap filtering for at least some vertical edges. Under 13-tap filtering, to perform vertical DB filtering on a specified edge of a block (e.g., a superblock) or sub-block of video data, the DB filter 310 can uses both pixel data from 7 lines of pixels on a first side of the specified edge and 7 lines of pixels to a second side of the specified edge, and modifies pixel data in up to 6 columns of pixels to the first side of the specified edge and 6 columns of pixels to the second side of the specified edge. For instance, in some examples, the DB filter 310 (e.g., the vertical DB filter 340 and/or the horizontal DB filter 345) filters based on Equation Set 1 below:

$$Equation Set 1$$

$$P {5}^{′} = ( P 6 * 7 + P 5 * 2 + P 4 * 2 + P 3 + P 2 + P 1 + P 0 + Q 0 + 8 ) ≫ 4$$

$$P {4}^{′} = ( P 6 * 5 + P 5 * 2 + P 4 * 2 + P 3 * 2 + P 2 + P 1 + P 0 + Q 0 + Q 1 + 8 ) ≫ 4$$

$$P {3}^{′} = ( P 6 * 4 + P 5 + P 4 * 2 + P 3 * 2 + P 2 * 2 + P 1 + P 0 + Q 0 + Q 1 + Q 2 + 8 ) ≫ 4$$

$$P {2}^{′} = ( P 6 * 3 + P 5 + P 4 + P 3 * 2 + P 2 * 2 + P 1 * 2 + P 0 + Q 0 + Q 1 + Q 2 + Q 3 + 8 ) ≫ 4$$

$$P {1}^{′} = ( P 6 * 2 + P 5 + P 4 + P 3 + P 2 + P 1 * 2 + P 0 + Q 0 + Q 1 + Q 2 + Q 3 + Q 4 + 8 ) ≫ 4$$

$$P {0}^{′} = ( P 6 + P 5 + P 4 + P 3 + P 2 + P 1 + P 0 * 2 + Q 0 * 2 + Q 1 + Q 2 + Q 3 + Q 4 + Q 5 + 8 ) ≫ 4$$

$$Q {0}^{′} = ( P 5 + P 4 + P 3 + P 2 + P 1 + P 0 * 2 + Q 0 * 2 + Q 1 * 2 + Q 2 + Q 3 + Q 4 + Q 5 + Q 6 + 8 ) ≫ 4$$

$$Q {1}^{′} = ( P 4 + P 3 + P 2 + P 1 + P 0 + Q 0 * 2 + Q 1 * 2 + Q 2 * 2 + Q 3 + Q 4 + Q 5 + Q 6 * 2 + 8 ) ≫ 4$$

$$Q {2}^{′} = ( P 3 + P 2 + P 1 + P 0 + Q 0 + Q 1 * 2 + Q 2 * 2 + Q 3 * 2 + Q 4 + Q 5 + Q 6 * 3 + 8 ) ≫ 4$$

$$Q {3}^{′} = ( P 2 + P 1 + P 0 + Q 0 + Q 1 + Q 2 * 2 + Q 3 * 2 + Q 4 * 2 + Q 5 + Q 6 * 4 + 8 ) ≫ 4$$

$$Q {4}^{′} = ( P 1 + P 0 + Q 0 + Q 1 + Q 2 + Q 3 * 2 + Q 4 * 2 + Q 5 * 2 + Q 6 * 5 + 8 ) ≫ 4$$

$$Q {5}^{′} = ( P 0 + Q 0 + Q 1 + Q 2 + Q 3 + Q 4 * 2 + Q 5 * 2 + Q 6 * 7 + 8 ) ≫ 4$$

In Equation Set 1 above, P0 through P0 represent pixels on the first side of the specified edge in the input video data 205, while Q0 through 6 represent pixels on the second side of the specified edge in the input video data 205. In Equation Set 1 above, P0′ through P6′ represent pixels on the first side of the specified edge in the DB-filtered block data 315, while Q0′ through Q6′ represent pixels on the second side of the specified edge in the DB-filtered block data 315. For vertical DB filtering (e.g., using the vertical DB filter 340), the specified edge may be a vertical edge, the first side of the specified edge may be the left side of the specified edge, and the second side of the specified edge may be the right side of the specified edge. For horizontal DB filtering (e.g., using the horizontal DB filter 345), the specified edge may be a horizontal edge, the first side of the specified edge may be the top side of the specified edge, and the second side of the specified edge may be the bottom side of the specified edge.

In some examples, the DB filter 310 (e.g., the vertical DB filter 340 and/or the horizontal DB filter 345) filters based on Equation Set 2 below:

$$Equation Set 2$$

$$refMiddle = ( {p}_{6} + {p}_{5} + {p}_{4} + {p}_{3} + {p}_{2} + {p}_{1} + 2 \times ( {p}_{0} + {q}_{0} ) + {q}_{1} + {q}_{2} + {q}_{3} + {q}_{4} + {q}_{5} + {q}_{6} + 8 ) ≫ 4.$$

$$refP = ( {p}_{6} + {p}_{5} + 1 ) ≫ 1 , and refQ = ( {q}_{6} + {q}_{5} + 1 ) ≫ 1.$$

$${f}_{0 … 6} = \{ 59 , 50 , 41 , 32 , 23 , 14 , 5 \} and {t}_{C} P {D}_{0 … 6} = \{ 6 , 5 , 4 , 3 , 2 , 1 , 1 \} .$$

$${g}_{0 … 6} = \{ 59 , 50 , 41 , 32 , 23 , 14 , 5 \} and {t}_{C} Q {D}_{0 … 6} = \{ 6 , 5 , 4 , 3 , 2 , 1 , 1 \} .$$

$${p}_{i}^{′} = Clip 3 ( {p}_{i} - ( {t}_{C} \times {t}_{C} P {D}_{i} ≫ 1 ) ,$$

$${p}_{i} + ( {t}_{C} \times {t}_{C} P {D}_{i} ≫ 1 ) , ( refMiddle \times {f}_{i} + refP \times ( 64 - {f}_{i} ) + 32 ) ≫ 6 )$$

$${q}_{j}^{′} = Clip 3 ( {q}_{j} - ( {t}_{C} \times {t}_{C} Q {D}_{j} ≫ 1 ) ,$$

$${q}_{j} + ( {t}_{C} \times {t}_{C} Q {D}_{j} ≫ 1 ) , ( refMiddle \times {g}_{j} + refQ \times ( 64 - {g}_{j} ) + 32 ) ≫ 6 )$$

In Equation Set 2 above, p₀ through p₆ represent pixels on the first side of the specified edge in the input video data 205, while q₀ through q₆ represent pixels on the second side of the specified edge in the input video data 205. In Equation Set 2 above, p₀′ through p₆′ (and pᵢ′ for different values of i) represent pixels on the first side of the specified edge in the DB-filtered block data 315, while q₀′ through q₆′ (and qⱼ′ for different values of j) represent pixels on the second side of the specified edge in the DB-filtered block data 315. For vertical DB filtering (e.g., using the vertical DB filter 340), the specified edge may be a vertical edge, the first side of the specified edge may be the left side of the specified edge, and the second side of the specified edge may be the right side of the specified edge. For horizontal DB filtering (e.g., using the horizontal DB filter 345), the specified edge may be a horizontal edge, the first side of the specified edge may be the top side of the specified edge, and the second side of the specified edge may be the bottom side of the specified edge. The filtered pixel values for a pixel at coordinates (i, j) can be determined using the value(s) of pᵢ′ and/or qⱼ′ determined using the equations above, with i={0, . . . , 6} and j={0, . . . , 6}. In some examples, Equation Set 1 is used in a first set of decoder(s) and/or video format(s), while Equation Set 2 is used in a second set of decoder(s) and/or video format(s). For instance, in an illustrative example, Equation Set 1 can be used by decoders using AOMedia Video 1 (AV1) or similar video coding formats. In an illustrative example, Equation Set 2 can be used by decoders using Versatile Video Coding (VVC) or similar video coding formats.

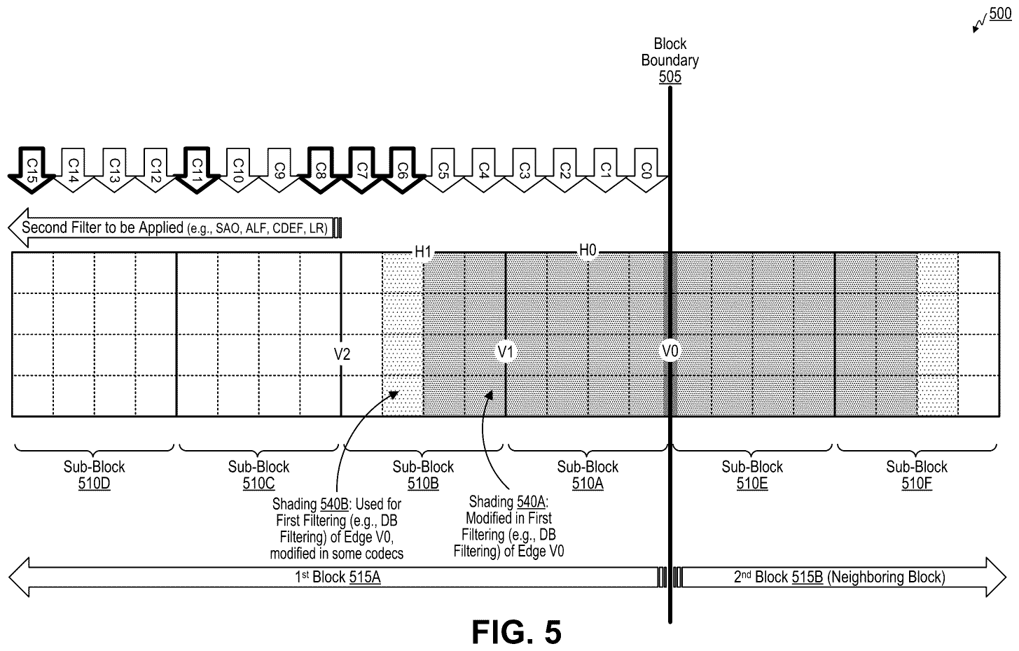

The decoder system 300 uses the SAO filter 320 to filter the DB-filtered block data 315 to reduce coding and banding artifacts in reconstructed image data and/or video data, not just at boundaries as in the DB filter 310. The decoder system 300 uses the SAO filter 320 to filter the DB-filtered block data 315 to generate SAO-filtered block data 325. The SAO-filtered block data 325 is an example of the second filtered block data 225, and may represent pixel data from the first block and/or the neighboring block that has been filtered using the SAO filter 320 and/or the DB filter 310. The SAO filter 320 is a 3-tap filter as illustrated in the box representing the SAO filter 320 in FIG. 3. Because the SAO filter 320 is a 3-tap filter, filtering 4×4 pixels in a row C11 (in reference to FIG. 5) requires fully filtered deblocked pixels at column C7. In some examples, the SAO filter 320 filters based on Equation 3 below:

$$y ( i , j ) = x ( i , j ) + {\sum }_{m = - 1 to 1} {\sum }_{n = - 1 to 1} Sign ( x ( i + m , j + n ) - x ( i , j ) ) \qquad Equation 3$$

The decoder system 300 uses the ALF 330 to reduce distortion introduced by the encoding process and improve reconstruction quality. The decoder system 300 uses the ALF 330 to filter the SAO-filtered block data 325 to generate ALF-filtered block data 335. The ALF-filtered block data 335 is an example of the third filtered block data 235 and/or the output block data 260, and may represent pixel data from the first block and/or the neighboring block that has been filtered using the ALF 330, the SAO filter 320, and/or the DB filter 310. In some examples, the ALF 330 applies classifications to partition sample locations into multiple classes and applies Wiener filters to the sample locations according to class. In some examples, the classifications are based on directionality and a quantized value of activity. The ALF 330 includes a luminosity (luma) ALF, which is a 7-tap filter, as illustrated on the left-hand side of the box representing the ALF 330 in FIG. 3. The ALF 330 includes a chroma (color) ALF, which is a 5-tap filter, as illustrated on the right-hand side of the box representing the ALF 330 in FIG. 3.

In some examples, the ALF-filtered block data 335 is the output block data 360. The output block data 360 is an example of the output block data 260. In some examples, the decoder system 300 passes the ALF-filtered block data 335 and/or the output block data 360 back through the filters of the decoder system 300 (e.g., the DB filter 310, the SAO filter 320, and/or the ALF 330) for an additional filtering cycle after the filtering cycle that was just completed through the generation of the ALF-filtered block data 335. Ultimately, the decoder system 300 outputs output block data 360 that has been filtered one or more times by each of the DB filter 310, the SAO filter 320, and/or the ALF 330. In some examples, the decoder system 300 can be associated with a specific codec or video format, such as Versatile Video Coding (VVC).

The DB filter 310 is a 13-tap filter. The SAO filter 320 is a 3-tap filter. The ALF 330 includes a 7-tap luma ALF and/or a 5-tap chroma ALF. In reference to the tap value variables for the filters of the decoder system 200—for the decoder system 300, N=13, M=3, and K=7 and/or K=5. For these tap values, maximum (N,M,K)=13. Because (maximum (N,M,K)−1)/2=(13−1)/2=12/2=6, the neighboring block line buffer 250 of the decoder system 300 should store at least 6 lines of pixels (e.g., rows or columns of pixels) of the neighboring block. However, because the DB filter is for filtering of boundaries of blocks and/or sub-blocks, the number of pixels from the neighboring block that are stored in the neighboring block line buffer 250 of the decoder system 300 should be a multiple of a sub-block size. In some examples, the sub-block is 4 pixels by 4 pixels (e.g., as illustrated in FIG. 5), which can be written as 4×4. To store at least 6 lines of pixels as multiple of the sub-block size, the decoder system 300 stores at least 8 lines of pixels (e.g., twice the size of the sub-block width and/or height) of the neighboring block. It should be understood that any block size can be used for the decoder system 200 (and thus the decoder system 300 and/or the decoder system 400), including 4×4, smaller than 4×4, or larger than 4×4.

In reference to the tap values for the filters of the decoder system 200 of FIG. 2, in some examples, the block and/or sub-block has sides (e.g., width and/or height) that are greater than or equal to (N−1)/2+(M−1)/2. In some examples, the block and/or sub-block can be non-symmetrical, in which case the width and/or height of the block and/or sub-block can be greater than or equal to (N−1)/2+(M−1)/2. In some examples, the block and/or sub-block can refer to a size of a processing unit. In some examples, the size of a processing unit (and thus the size of the block and/or sub-block) can vary between luma processing and chroma processing, for instance being 8×8 for luma processing and 4×4 for chroma processing. In some examples, the size of the block and/or sub-block can be the maximum processing unit size, between luma and chroma, of any filter to be applied, so for the above example where processing unit sizes are 8×8 for luma processing and 4×4 for chroma processing, then the size of the block and/or sub-block would be set to 8×8.

In some examples, in a decoder system 300 with 4:2:0 chroma sub-sampling where the neighboring block is located to the left of the first block in the video frame, the amount of data written to, stored in, and read from the neighboring block line buffer 250 from and/or for the DB filter 310 can be determined as in Equation Set 4 below:

$$DB Luma left nbr buffer size = 8 * Luma\_Tile \_Height DB CB left nbr buffer size = 4 * Luma\_Tile \_Height * 1 / 2 DB CR left nbr buffer size = 4 * Luma\_Tile \_Height * 1 / 2 \qquad Equation Set 4$$

In some examples, in a decoder system 300 with 4:2:0 chroma sub-sampling where the neighboring block is located to the left of the first block in the video frame, the amount of data written to, stored in, and read from the neighboring block line buffer 250 from and/or for the SAO filter 320 can be determined as in Equation Set 5 below:

$$SAO Luma left nbr buffer size = 5 * Luma\_Tile \_Height SAO CB left buffer size = 5 * Luma\_Tile \_Height * 1 / 2 SAO CR left buffer size = 5 * Luma\_Tile \_Height * 1 / 2 \qquad Equation Set 5$$

In some examples, in a decoder system 300 with 4:2:0 chroma sub-sampling where the neighboring block is located to the left of the first block in the video frame, the amount of data written to, stored in, and read from the neighboring block line buffer 250 from and/or for the ALF 330 can be determined as in Equation Set 6 below:

$$ALF Luma left nbr buffer size = 7 * Luma\_Tile \_Height ALF CB left buffer size = 6 * Luma\_Tile \_Height * 1 / 2 ALF CR left buffer size = 6 * Luma\_Tile \_Height * 1 / 2 \qquad Equation Set 6$$

In some examples, in a decoder system 300 with 4:2:0 chroma sub-sampling where the neighboring block is located to the left of the first block in the video frame, the total amount of data written to, stored in, and read from the neighboring block line buffer 250 (e.g., from and/or for the DB filter 310, the SAO filter 320, and/or the ALF 330) can be determined as in Equation 7 below:

$$Total left nbr buffer size = ( 35 * Luma\_Tile \_Height ) \qquad Equation 7$$

In some examples, in a frame configured for the DB filter 310, the SAO filter 320, and/or the ALF 330 having two vertical tiles and no horizontal tile, the tile height may be equal to the frame height. For a frame height H, the total amount of data written to, stored in, and read from the neighboring block line buffer 250 (e.g., from and/or for the DB filter 310 and/or the CDEF 420) of the decoder system 300 can be determined as in Equation 8 below:

$$Total left nbr buffer size = 35 * H pixels \qquad Equation 8$$

In some examples, for frame rate (F frames per sec), minimum read/write memory bandwidth for writing data to and/or reading data from the neighboring block line buffer 250 in the decoder system 300 is indicated in Equation 9 below:

$$Memory Bandwidth = 35 * H * F pixels / sec \qquad Equation 9$$

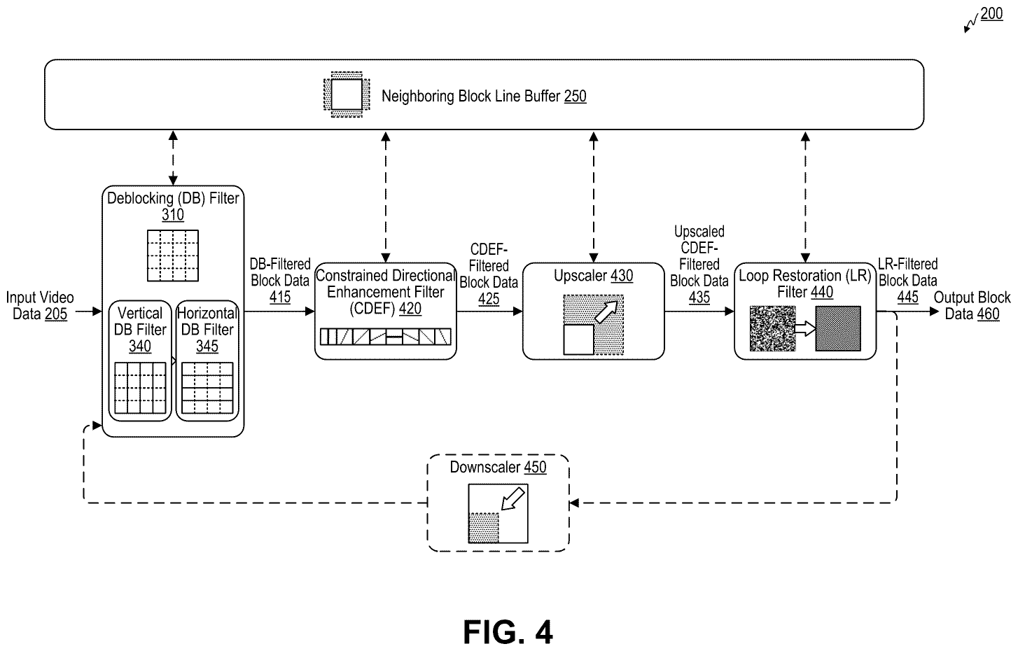

FIG. 4 is a block diagram illustrating a decoder system 400 in which the first filter 210 is a deblocking (DB) filter 310, the second filter 220 is a constrained directional enhancement filter (CDEF) 420, and the third filter 230 is a loop restoration (LR) filter 440. The decoder system 400 is an example of the decoder system 200. In some examples, the decoder system 400 may be an example of the decoding device 112, the decoder engine 116, decoder system 200, the decoder system 600, the decoder system 700, the codec system that performs the codec process 800, the computing system 900, or a combination thereof.

The first filter 210 of the decoder system 400 is the DB filter 310, similarly to the decoder system 300. In some examples, the decoder system 400 applies the DB filter 310 (e.g., including the vertical DB filter 340 and/or the horizontal DB filter 345) to the input video data 205 as the decoder system 300 does, to generate the DB-filtered block data 315 (e.g., in some examples including DB-filtered neighboring block data from a neighboring block).

The decoder system 400 can filter the DB-filtered block data 315 using the CDEF 420 to generate CDEF-filtered block data 425. To filter the DB-filtered block data 315 using the CDEF 420, the decoder system 400 can also retrieve the DB-filtered neighboring block data from the neighboring block line buffer 250, and use the DB-filtered neighboring block data as well as the DB-filtered block data 315 as inputs to the CDEF 420 to generate the CDEF-filtered block data 425. The CDEF 420 can remove ringing and basis noise around sharp edges in the DB-filtered block data 315. In some examples, the CDEF 420 can be a direction filter that follow edges based on direction of the edges, for instance performing a direction search using the DB-filtered block data 315. In some examples, CDEF 420 can operate in 8 different directions (e.g., from 0 to 7). A graphic representing the CDEF 420 in FIG. 2 illustrates example block edges oriented according to each of the 8 different directions.

In In some examples, the CDEF 420 calculates a mean square error (MSE) for each pixel in the DB-filtered block data 315 by subtracting 128 from the pixel value and squaring the difference. For each line (k) present in a particular direction (d), the CDEF 420 can add the MSE for all of the pixels, multiply the sum by 840, and divide by a number of pixels present in the line (N_{d,k}). For instance, 840 may represent a least common multiple of N_{d,k}. In this way, the CDEF 420 can normalize MSE for each line, as the number of pixels can be different for each line. The CDEF 420 can calculate direction strength for each direction (s_{d}) by adding the MSE for all lines present in that direction. For instance, these calculations may be represented as in Equation 10 below:

$${s}_{d} = {\sum }_{k} \frac{840}{{N}_{d , k}} {( {\sum }_{p ∈ {P}_{d , k}} ( x - 128 ) )}^{2} ; \qquad Equation 10$$

In some examples, the CDEF 420 can select the strongest direction strength (s_{d}) as a selected direction dₒₚₜ, for instance as in Equation 11 below:

$${d}_{o p t} : {s}_{o p t} = {max}_{d} {s}_{d} \qquad Equation 11$$

In some examples, the CDEF 420 uses 5-tap filtering. Thus, to perform CDEF filtering on a specified area of the DB-filtered block data 315, the CDEF 420 uses both pixel data from 2 lines of pixels to a first side of the specified area of pixels and 2 lines of pixels to a second side of the specified area of pixels. In some examples, the first side of the specified area may be the left side of the specified area, and the second side of the specified area may be the right side of the specified area. In some examples, the first side of the specified area may be the top side of the specified area, and the second side of the specified area may be the bottom side of the specified area. In some examples, the CDEF 420 uses both pixels from all sides of the specified area (e.g., top, right, bottom, and left) to CDEF-filter the DB-filtered block data 315. For instance, in some examples, the CDEF 420 filters based on Equation 12 below:

$$y ( i , j ) = x ( i , j ) + {\sum }_{m = - 2 to 2} {\sum }_{n = - 2 to 2} x ( i + m , j + n ) * ( pri\_dir ( i , j ) + sec\_dir ( i , j ) ) \qquad Equation 12$$

In Equation 12 above, m and n can represent the lines of pixel data around the specified area being filtered using the CDEF 420.

In some examples, the CDEF 420 performs a direction search using the DB-filtered block data 315.

The decoder system 400 passes the CDEF-filtered block data 425 generated using the CDEF 420 to the upscaler 430 to generate upscaled CDEF-filtered block data 435 using the upscaler 430. The upscaler 430 upscales the CDEF-filtered block data 425 by an upscaling factor to generate the upscaled CDEF-filtered block data 435. In an illustrative example, the upscaling factor is 2. In some examples, the upscaling factor can be 1.125, 1.25, 1.5, 1.75, 2, 3, 4, 5, 6, 7, 8, 9, 10, a higher upscaling factor than 10, a lower upscaling factor than 1.125, an upscaling factor between any two previously-listed upscaling factors, or another appropriate upscaling factor. A graphic representing the upscaler 430 in FIG. 4 illustrates upscaling of a block by a factor of 2. In some examples, the decoder system 400 also includes a downscaler 450, discussed further below. The scaling factor used by the downscaler 450 can match the scaling factor used by the upscaler 430. The upscaler 430 and/or the downscaler 450 can use any rescaling technique(s), such as resampling, resizing, nearest-neighbor interpolation, bilinear interpolation, bicubic interpolation, sinc resampling, Lanczos resampling, box sampling, mipmapping, interpolation based on Fourier transform(s), edge-directed interpolation, high-quality scaling (HQX), vectorization, super-resolution, deep convolutional neural network(s), or a combination thereof. In some examples, the upscaler 430 and/or the downscaler 450 perform horizontal rescaling without vertical rescaling. In some examples, the upscaler 430 and/or the downscaler 450 perform vertical rescaling without horizontal rescaling. In some examples, the upscaler 430 and/or the downscaler 450 perform both horizontal rescaling and vertical rescaling.

The decoder system 400 passes the upscaled CDEF-filtered block data 435 to a loop restoration (LR) filter 440. In some examples, the decoder system 400 also retrieves neighboring block data (e.g., which may be DB-filtered, CDEF-filtered, and/or upscaled) from the neighboring block line buffer 250, and passes the neighboring block data to the LR filter 440. The decoder system 400 uses the LR filter 440 to filter the upscaled CDEF-filtered block data 435 to generate LR-filtered block data 445 and/or the output block data 460. In some examples, the LR-filtered block data 445 is the output block data 460. In some examples, the decoder system 400 passes the LR-filtered block data 445 and/or the output block data 460 back through the filters of the decoder system 400 (e.g., the DB filter 310, the CDEF 420, the upscaler 430, and/or the LR filter 440) for an additional filtering cycle after the filtering cycle that was just completed through the generation of the LR-filtered block data 445. Because the upscaler 430 upscales the CDEF-filtered block data 435 before the LR filter 440 is applied, in situations where the decoder system 400 passes the LR-filtered block data 445 and/or the output block data 460 back to the DB filter 310 of the decoder system 400, the decoder system 400 can use the downscaler 450 to downscale the LR-filtered block data 445 and/or the output block data 460 before the additional filtering cycle. In this way, the DB filter 310 receives an input of the size that it expects, and each filtering cycle does not continue to increase the size of the video data. Ultimately, the decoder system 400 outputs output block data 460 that has been filtered one or more times by each of the DB filter 310, the CDEF 420, the upscaler 430, and/or the LR filter 440. In some examples, the decoder system 400 can be associated with a specific codec or video format, such as AOMedia Video 1 (AV1).

In some examples, to filter the upscaled CDEF-filtered block data 435 using the LR filter 440, the decoder system 400 can also use the neighboring block data as well as the CDEF-filtered block data 255 as inputs to the LR filter 440 to generate the output block data 260. The LR filter 440 can include one or more configurable filters and/or switchable filters, such as one or more Wiener filters and/or one or more self-guided filters. In some examples, the LR filter 440, and/or the filter(s) that the LR filter 440 includes, include one or more convolving filters that are configured to build a kernel to restore lost quality of the input data (e.g., the upscaled CDEF-filtered block data 435). In some examples, the LR filter 440 is used for denoising and/or edge enhancement, for instance to remove DCT basis noise using configurable amount(s) of blurring. A graphic representing the LR filter 440 in FIG. 4 illustrates exemplary removal (e.g., smoothing) of noise.

In some examples, the LR filter 440 uses 7-tap filtering. Thus, to perform LR filtering on a specified area of the upscaled CDEF-filtered block data 435, the LR filter 440 uses both pixel data from 3 lines of pixels to a first side of the specified area of pixels and 3 lines of pixels to a second side of the specified area of pixels. In some examples, the first side of the specified area may be the left side of the specified area, and the second side of the specified area may be the right side of the specified area. In some examples, the first side of the specified area may be the top side of the specified area, and the second side of the specified area may be the bottom side of the specified area. In some examples, the LR filter 440 uses both pixels from all sides of the specified area (e.g., top, right, bottom, and left) to LR-filter the upscaled CDEF-filtered block data 435. For instance, in some examples, the LR filter 440 filters based on Equation Set 13 below:

$${y}^{′} ( i , j ) = {\sum }_{m = - 3 to 3} horz\_coeff * x ( i + m , j ) y ( i , j ) = {\sum }_{n = - 3 to 3} vert\_coeff * {y}^{′} ( i , j + n ) \qquad Equation Set 13$$

In Equation Set 13 above, m and n can represent the lines of pixel data around the specified area being filtered using the LR filter 440.

In some examples, the decoder system 400 can pass the output of the LR filter 440 (e.g., the output block data 260) back to the DB filter 310 for another loop or cycle through the DB filter 310, the CDEF 420, the upscaler 430, the LR filter 440, and/or the neighboring block line buffer 250. In this way, the output block data 260 can be used as at least a portion of the input video data 205 (e.g., the portion representing the first block). This repetition of this filtering process can be referred to as a coding loop, and is represented in FIG. 4 by a dashed line arrow from the LR filter 440 back to the DB filter 310, which in some cases can also pass through the downscaler 450 as discussed above. In some examples, the output block data 460 may refer to the output of multiple repetitions of the filtering process in the coding loop. In some examples, the coding loop can also refer to filtering of different blocks in the video frame through the DB filter 310, the CDEF 420, the upscaler 430, the LR filter 440, and/or the neighboring block line buffer 250.

In some examples, the neighboring block line buffer 250 may store DB-filtered pixel data from a plurality of lines of a neighboring block that neighbors the first block. The neighboring block can be located adjacent to the first block within the context of the video frame. In some examples, the neighboring block is located to the left of the first block within the context of the video frame. In some examples, the neighboring block is located above the first block within the context of the video frame. In some examples, the neighboring block is located to the right of the first block within the context of the video frame. In some examples, the neighboring block is located below the first block within the context of the video frame. In some examples, the first block and/or the neighboring block can be superblocks, macroblocks, and/or tiles.

In some examples, in a decoder system 400 with 4:2:0 chroma sub-sampling where the neighboring block is located to the left of the first block in the video frame, the amount of data written to, stored in, and read from the neighboring block line buffer 250 from and/or for the DB filter 310 can be determined as in Equation Set 4 above.

In some examples, in a decoder system 400 with 4:2:0 chroma sub-sampling where the neighboring block is located to the left of the first block in the video frame, the amount of data written to, stored in, and read from the neighboring block line buffer 250 from and/or for the CDEF 420 can be determined as in Equation Set 14 below:

$$CDEF Luma left nbr buffer size = 10 * Luma\_Tile \_Height CDEF CB left buffer size = 6 * Luma\_Tile \_Height * 1 / 2 CDEF CR left buffer size = 6 * Luma\_Tile \_Height * 1 / 2 \qquad Equation Set 14$$

In some examples, in a decoder system 400 with 4:2:0 chroma sub-sampling where the neighboring block is located to the left of the first block in the video frame, the total amount of data written to, stored in, and read from the neighboring block line buffer 250 (e.g., from and/or for the DB filter 310 and/or the CDEF 420) can be determined as in Equation 15 below:

$$Total ( DB + CDEF ) left nbr buffer size = ( 28 * Luma\_Tile \_Height ) \qquad Equation 15$$

In some examples, in a frame configured for the DB filter 310 and/or the CDEF 420, having two vertical tiles and no horizontal tile, the tile height may be equal to the frame height. For a frame height H, the total amount of data written to, stored in, and read from the neighboring block line buffer 250 (e.g., from and/or for the DB filter 310 and/or the CDEF 420) of the decoder system 400 can be determined as in Equation 16 below:

$$Total ( DB + CDEF ) left nbr buffer size = 28 * H pixels \qquad Equation 16$$

In some examples, for frame rate (F frames per see), minimum read/write memory bandwidth for writing data to and/or reading data from the neighboring block line buffer 250 of the decoder system 400 is indicated in Equation 17 below:

$$Memory Bandwidth = 28 * H * F pixels / sec \qquad Equation 17$$

FIG. 5 is a conceptual diagram illustrating a block layout 500 with a block boundary 505 between a first block 515A and a second block 515B, with both blocks divided into sub-blocks 510A-510F. The first block 515A, the second block 515B, and the sub-blocks 510A-510F may each be blocks, superblocks, macroblocks, tiles, CUs, CTUs, or any other block types described herein. The first block 515A and the second block 515B are larger than the sub-blocks 510A-510F. In some examples, the sub-blocks 510A-510F may be referred to as blocks, while the first block 515A and the second block 515B may be referred to as superblocks, macroblocks, LCUs, and/or tiles.

The sub-blocks 510A-510F represent a row of sub-blocks. Additional sub-blocks may be above or below any of the sub-blocks 510A-510F. There may be additional sub-blocks to the left of the sub-block 510D, and/or to the right of the sub-block 510F. The first block 515A includes sub-blocks 510A-510D, and may include additional sub-blocks beyond the sub-blocks 510A-510D. The second block 515B includes sub-blocks 510E-510F, and may include additional sub-blocks beyond the sub-blocks 510E-510F. In some examples, the dimensions of the first block 515A and/or the second block 515B are 64 pixels by 64 pixels. In some examples, the dimensions of the sub-blocks 510A-510F are 4 pixels by 4 pixels, with boundaries between pixels illustrated using the dashed lines within each of the sub-blocks 510A-510F. Columns in the sub-blocks 510A-510D of the first block 515A are numbered from C0 to C15 based on how far away the columns are from the block boundary 505 between the first block 515A and the second block 515B. The block boundary 505 may be referred to as the block edge between the first block 515A and the second block 515B.

The block boundary 505 represents the right edge of the first block 515A and/or the left edge of the second block 515B. A first filter 210 is applied to pixels in the first block 515A and/or the second block 515B as illustrated in the shading 540A and/or the shading 540B. In the example illustrated in FIG. 5, the pixels with shading 540A (e.g., columns C0 through C5, as well as the 6 columns of pixel data in the second block 515A that are nearest to the block boundary 505) represent pixels that are modified in the first filtering (using the first filter 210) of the edge V0. In the example illustrated in FIG. 5, the pixels with shading 540B (e.g., column C6 as well as the 7th column of pixel data to the right of the block boundary 505) represent pixels that are used in the first filtering (using the first filter 210) of the edge V0 (e.g., as neighboring pixel information), but not necessarily modified in the first filtering (using the first filter 210) of the edge V0. In some examples, the pixels with shading 540B (e.g., column C6 as well as the 7th column of pixel data to the right of the block boundary 505) are also modified in the first filtering (using the first filter 210) of the edge V0. In the example illustrated in FIG. 5, the first filter 210 is the DB filter 310. In some examples, under some codecs or formats (e.g., AV1), the DB filter 310 uses but doesn't modify the pixels with shading 540B, whereas under other codecs or formats (e.g., VVC), the DB filter 310 modifies the pixels with shading 540B. In some examples, the first filter 210 can be another type of filter other than the DB filter 310.

In some cases, certain video codecs and/or formats (e.g., AV1, VVC) can specify that for DB filtering using the DB filter 310, the decoder system 200 first vertically filters blocks and/or sub-blocks of video data using the vertical DB filter 340, and then horizontally filters the blocks and/or sub-blocks of the video data using the horizontal DB filter 345. In some examples, the vertical DB filter 340 and/or the horizontal DB filter 345 use 13-tap filtering for at least some edges. For instance, the vertical DB filter 340 can use 13-tap filtering for edge V0 (e.g., the block boundary 505). In the context of the vertical DB filter 340, 13-tap filtering means that, to perform vertical DB filtering on a specified edge of a block or sub-block of video data, the vertical DB filter 340 uses both pixel data from 7 columns of pixels to the left of the specified edge and 7 columns of pixels to the right of the specified edge, and modifies pixel data in up to 6 columns of pixels to the left of the specified edge and 6 columns of pixels to the right of the specified edge.

For example, pixels with shading 540A (e.g., columns C0 through C5, as well as the 6 columns of pixel data in the second block 515A that are nearest to the block boundary 505) can be modified by the vertical DB filter 340 when the vertical DB filter 340 performs vertical DB filtering on the vertical edge V0. The vertical edge V0 represents the part of the block boundary 505 that is a boundary between the sub-block 510A and the sub-block 510E. The vertical DB filter 340 can use the pixels with shading 540B (e.g., column C6 as well as the 7th column of pixel data to the right of the block boundary 505) as well as the pixels with shading 540A to perform vertical DB filtering on the vertical edge V0. The pixels with shading 540B are used by the vertical DB filter 340 to perform vertical DB filtering on the vertical edge V0, but are not modified by the vertical DB filter 340 in performing vertical DB filtering on the vertical edge V0. In some examples, the vertical DB filter 340 and/or the horizontal DB filter 345 uses other filtering schemes (other than 13-tap filtering) for other edges than V0, such as edges V1 and/or V2. For instance, in some examples, the vertical DB filter 340 can use 4-tap, 5-tap, 6-tap, 7-tap, or 8-tap filtering for edges V1 and/or V2.

In some examples, pixel data from the second block 515B is not available to the first filter 210 (e.g., the DB filter 310) when the first filter 210 is used to filter the first block 515A. In some such examples, the DB filter 310 cannot perform vertical DB filtering (e.g., using vertical DB filter 340) on any vertical edges of the sub-block 510A of the first block 515A, since pixel data from the second block 515B would be necessary to perform vertical DB filtering on any vertical edges of the sub-block 510A. Because of this, a decoder system that uses the block layout (e.g., the decoder system 200, the decoder system 300, the decoder system 400, the decoder system 600, and/or the decoder system 700) stores the pixel data from the sub-block 510A in the neighboring block line buffer 250, retrieves the pixel data from the sub-block 510A from the neighboring block line buffer 250 when performing DB filtering of the second block 515B, and performs DB filtering (e.g., vertical and horizontal) on the edges of the sub-block 510A, and on the block boundary 505, during filtering of the second block 515B.

In some examples, the DB filter 310 applies the horizontal DB filter 345 to horizontal edges of a sub-block only after successfully applying the vertical DB filter 340 to the vertical edges of the sub-block. Thus, if the vertical DB filter 340 does not filter the vertical edges of the sub-block 510 (e.g., edges V0 and V1), the horizontal DB filter 345 will likewise not filter the horizontal edges of the sub-block 510A (e.g., edge H0). The DB filter 310 not filtering the edges of the sub-block 510A can, in turn, prevent the decoder system from applying a second filter 220 (e.g., SAO filter 320, ALF 330, CDEF 420, upscaler 430 and/or LR filter 440) to the sub-block 510A.

In some examples, the DB filter 310 performs DB filtering for an entire sub-block at a time. In some examples where the pixel data from the second block 515B is not available to the DB filter 310 when the DB filter 310 is used to filter the first block 515A, the right edge V1 of the sub-block 510B cannot be vertically filtered by the vertical DB filter 340, though the left edge V2 of the sub-block 510B can be vertically filtered by the vertical DB filter 340, for instance if the right edge V1 is configured for 13-tap filtering. In some examples where the pixel data from the second block 515B is not available to the DB filter 310 when the DB filter 310 is used to filter the first block 515A, the right edge V1 of the sub-block 510B and left edge V2 of the sub-block 510B can both be vertically filtered by the vertical DB filter 340, for instance if the edges V1 and V2 are configured for 4-tap, 5-tap, 6-tap, 7-tap, or 8-tap filtering. The inability to vertically portions of sub-block 510B can prevent the vertical DB filter 340 from fully vertically DB-filtering portions of the sub-block 510B (e.g., near edge V1 due to the 13-tap filtering for edge V0), which in turn can prevent the horizontal DB filter 345 from filtering the horizontal edges of the sub-block 510B (e.g., edge H1). The DB filter 310 not fully filtering the edges of the sub-block 510B can, in turn, prevent the decoder system 200 from applying the second filter 220 (e.g., SAO filter 320, ALF 330, CDEF 420, upscaler 430 and/or LR filter 440) to the sub-block 510B.

In examples where the DB filter 310 performs DB filtering for an entire sub-block at a time, the decoder system 200 can store the pixel data from the sub-block 510B in the neighboring block line buffer 250, as with the pixel data from the sub-block 510A. In such examples, the decoder system 200 then retrieves the pixel data from the sub-blocks 510A-510B from the neighboring block line buffer 250 when performing DB filtering of the second block 515B, and performs DB filtering (e.g., vertical and horizontal) on the edges of the sub-blocks 510A-510B, and on the block boundary 505, during filtering of the second block 515B.

In some examples, the second filter 220 includes the SAO filter 320 and/or the ALF 330, as in the decoder system 300 of FIG. 3. In some such examples, the SAO filter 320 and/or the ALF 330 can filter a 4 pixel by 4 pixel area at a time in the luma and chroma spaces. In some examples the SAO filter 320 uses 3-tap filtering, Thus, to filter a specified area of pixels using the SAO filter 320, the SAO filter 320 uses both pixel data from 1 columns of pixel to the left of the specified area of pixels and 1 columns of pixels to the right of the specified area of pixels. In some examples, any data that the SAO filter 320 uses for SAO filtering should already be fully DB filtered (e.g., vertically DB filtered as well as horizontally DB filtered). Thus, in order to perform SAO filtering on a pixel that is 9 pixels to the left of a right edge of the block, the pixel data in pixel(s) that are 8 pixels to the left of the right edge of the block would need to be DB filtered. However, under traditional decoding techniques, the pixel data in in the pixel(s) that are 8 pixels to the left of the right edge of the block would need is not fully DB filtered. This pixel data can be missing horizontal DB filtering and/or vertical DB filtering. For instance, this pixel data can be vertically DB filtered without being horizontally DB filtered. This, in turn, can prevent certain sub-blocks (e.g., sub-block 510C) from being SAO-filtered.

In some such examples, some of the pixels stored in the neighboring block line buffer 250 are partially filtered, for instance filtered using the vertical DB filter 340 but not the horizontal DB filter 345. In some examples, the ALF 330 filtering process is defined for sub-blocks having sub-block sizes of 4×4 as illustrated in FIG. 5, for instance under VVC. The SAO filter 320 is thus applied to sub-blocks having sub-block sizes of 4×4, both in the luma and chroma spaces, to provide intermediate data (e.g., the SAO-filtered data 325) from the SAO filter 320 to the ALF 330. Because the SAO filter 320 is a 3-tap filter, filtering sub-block 510C (between and including columns C8 and C11) relies on fully DB-filtered pixels at column C7. Since edge H1 of sub-block 510B is not fully DB-filtered as illustrated in FIG. 5, SAO filtering (and thus ALF filtering) of the sub-block 510C is delayed until filtering of the second block 515B, and columns C8 to C11 (which include sub-block 510C) are stored in the neighboring block line buffer 250 to be accessible during filtering of the second block 515B. An additional 1 pixel column of DB-filtered data (C12) would then also be stored in the neighboring block line buffer 250 to be accessible during filtering of the second block 515B, for use in SAO filtering and/or ALF filtering of the pixel data in columns C8 to C11 (which include sub-block 510C). Since the ALF filtering process is performed over sub-block sizes of 4×4, the neighboring block line buffer 250 also stores an additional 4 columns of pixels that have been SAO filtered but not ALF filtered. Because and the ALF luma filter is a 7-tap filter and the ALF chroma filter is a 5-tap filter, the neighboring block line buffer 250 also stores an additional 3 columns of pixels that have been SAO filtered that are stored for use as neighbor data for ALF filtering of the previously-mentioned 4 columns of pixels that have been SAO filtered but not ALF filtered.

In some examples, the second filter 220 includes the CDEF 420 and/or the LR filter 440, as in the decoder system 400 of FIG. 4. In some such examples, the CDEF 420 filters an 8 pixel by 8 pixel area at a time in the luma space, and a 4 pixel by 4 pixel area at a time in the chroma space. In some examples, the CDEF 420 uses 5-tap filtering. Thus, to filter a specified area of pixels using CDEF filtering, the CDEF filtering algorithm uses both pixel data from 2 columns of pixels to the left of the specified area of pixels and 2 columns of pixels to the right of the specified area of pixels. In some examples, any data that the CDEF 420 uses for CDEF filtering should already be fully DB filtered by the DB filter 310 (e.g., vertically DB filtered by the vertical DB filter 340 as well as horizontally DB filtered by the horizontal DB filter 345). Thus, in order to perform CDEF filtering on an area that includes the sub-blocks 510C-510D (e.g., between column C8 and column C15), the CDEF 420 is configured to use fully DB-filtered pixel data from columns C7 and C6. Column C6 is six pixels horizontally away (e.g., leftward) from the block boundary 505. Column C7 is seven pixels horizontally away (e.g., leftward) from the block boundary 505. However, in examples where the DB filter 310 performs DB filtering for an entire sub-block at a time as described above, the DB filter 310 does not perform DB-filtering on the pixel data in columns C7 and C6. This, in turn, prevents the CDEF 420 from being able to perform CDEF filtering on the area that includes the sub-blocks 510C-510D (e.g., between column C8 and column C15).

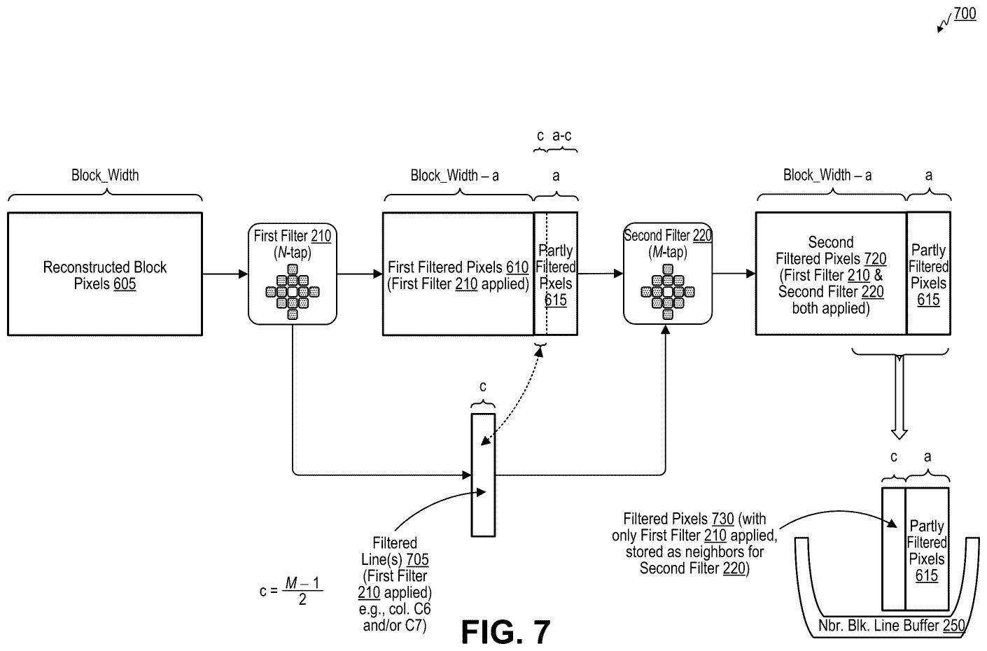

However, in some examples where the vertical DB filtering algorithm uses 13-tap filtering as described above, the vertical DB filter 340 can perform vertical DB filtering for the left edge V2 of the sub-block 510B, and for the pixel data in the columns C6 and C7 of the sub-block 510B. For instance, column C7 is neither used nor modified by vertical DB filtering of the block boundary 505, while column C6 is used but not modified by the vertical DB filtering of the block boundary 505. Because the vertical DB filter 340 can perform vertical DB filtering on the pixel data in the columns C6 and C7 of the sub-block 510B, the horizontal DB filter 340 can perform horizontal DB filtering for portions of the horizontal edges (e.g., edge H1) of the sub-block 510B that are in columns C6 and C7 of the sub-block 510B. Thus, the DB filter 310 can fully DB-filter the pixel data in columns C6 and C7 of the sub-block 510B, without fully DB-filtering other portions of the sub-block 510B (e.g., columns C4 and C5). In examples where the CDEF 420 uses 5-tap filtering as described above, the DB filter 310 performing full DB-filtering on columns C6 and C7 of the sub-block 510B allows the CDEF 420 to perform full CDEF filtering on the area that includes the sub-blocks 510C-510D (e.g., between column C8 and column C15). The CDEF 420 being able to perform full CDEF filtering on the area that includes the sub-blocks 510C-510D (e.g., between column C8 and column C15) in turn allows the decoder system 200 to perform upscaling of this area using the upscaler 430, and/or to perform LR filtering of this area (as upscaled) using the LR filter 440. The CDEF 420 being able to perform full CDEF filtering on this area thus eliminates the need for the decoder system 200 to store DB-filtered pixel data from the sub-blocks 510C-510D in the neighboring block line buffer 250. In some examples, this decreases how much data is to be stored in the neighboring block line buffer 250 by 44%. An example of this filtering process that CDEF-filters the sub-blocks 510C-510D, and thus does not need to store the DB-filtered pixel data of the sub-blocks 510C-510D in the neighboring block line buffer 250, is illustrated in FIG. 7.

In some examples, the decoder system 300 and the decoder system 400 may differ in important ways. In some examples, different codecs and/or video coding formats may also differ in how certain filters may be applied. For instance, when DB filtering the edge V0 (of the block boundary 505), the DB filter 310 may modify the pixels with the shading 540A (e.g., columns C0 through C5 in the first block 515A and/or corresponding 6 rows in the second block 515B) under AV1, and may modify the pixels with the shading 540A and with the shading 540B (e.g., columns C0 through C6 in the first block 515A and/or corresponding 7 rows in the second block 515B) under VVC. C6 remaining unmodified is important to allow application of the CDEF 420, since the CDEF 420 is a 5-tap filter. C6 remaining unmodified allows horizontal DB-filtering of pixel columns C6 and C7 of edge H1 before filtering V0 (e.g., c=2 in the decoder system 600 and/or the decoder system 700). On the other hand, C6 need not remain unmodified for application of the SAO filter 320, as the SAO filter 320 is a 3-tap filter and thus only needs column C7 to remain unmodified while filtering edge V0, allowing C7 to be horizontal DB-filtered before filtering V0 (e.g., c=1 in the decoder system 600 and/or the decoder system 700).

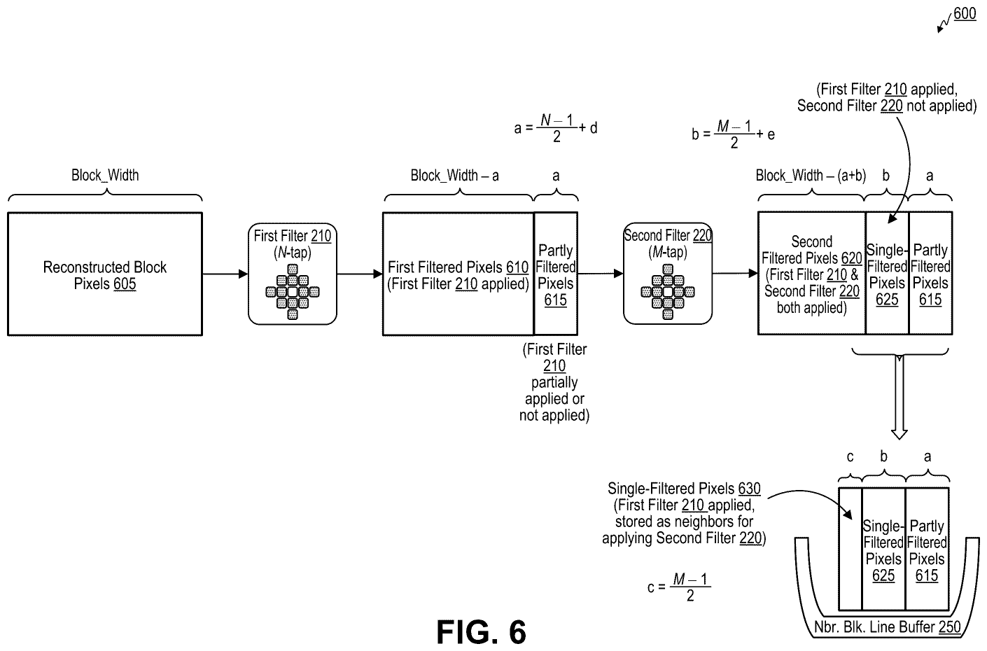

FIG. 6 is a block diagram illustrating a decoder system 600 that applies a first filter 210 and a second filter 220 to a block of video data. The decoder system 600 can be an example of the decoding device 112, the decoder engine 116, the decoder system 200, the decoder system 300, the decoder system 400, the codec system that performs the codec process 800, the computing system 900, or a combination thereof. The block of video data can be an example of the first block 515A.

The decoder system 600 receives reconstructed block pixels 605. The reconstructed block pixels 605 may be reconstructed from an encoded video, such as a video encoded using the encoding device 104. Examples of the reconstructed block pixels 605 include the output 110, the input 114, the input video data 205, the video data of operation 805, or a combination thereof. In some examples, the reconstructed block pixels 605 are received using the communications link 120. In some examples, the reconstructed block pixels 605+at least partially decoded using the decoding device 112 (e.g., using the decoder engine 116), for instance by performing entropy decoding, rescaling, and/or an inverse transform as discussed with respect to FIG. 1. The reconstructed block pixels 605 include a block having a block width identified as Block_Width. An example of the block includes the first block 515A or the second block 515B.

The first filter 210 is applied to the reconstructed block pixels 605 to generate first filtered pixels 610 to which the first filter 210 is applied. In some examples (e.g., as in the decoder system 300 and/or the decoder system 400), the first filter 210 may be a DB filter 310. The first filtered pixels 610 does not filter the entire block. In some examples, a columns remain unfiltered or only partly filtered using the first filter 210. Thus, the first filtered pixels 610 include Block_Width-a columns of pixel data.

The value of a can be calculated as

$$a = \frac{N - 1}{2} + d .$$

Here, N is the tap value of the first filter 210. In some examples, d=0. In some examples, d is used to round a up to the nearest multiple of the size that the first filter 210 applies to (e.g., of the size of the width of a sub-block). For instance, if the first filter 210 is the DB filter 310, then N=13. Thus, if the first filter 210 is the DB filter 310, then

$$a = \frac{13 - 1}{2} + d = 6 + d .$$

If the sub-block size is 4×4 as illustrated in block layout 500 of FIG. 5, then d=2, so that a=8.

In examples, where the first filter 210 is the DB filter 310, the DB filter 310 performs DB filtering (e.g., vertical DB filtering using the vertical DB filter 340 and/or horizontal DB filtering using the horizontal DB filter 345) on the reconstructed block pixels 605 to so that the first filtered pixels 610 are fully DB-filtered pixels. The partly-filtered pixels 615 are partly DB-filtered, for instance being vertically DB filtered (e.g., using the vertical DB filter 340) but not horizontally DB filtered (e.g., using the horizontal DB filter 345), for instance because of the challenge of filtering edge H1 of the sub-block 510B when columns C6 and/or C7 are not modified by the DB filter 310 as illustrated in FIG. 5. As noted above, where the first filter 210 is the DB filter 310, a=8, so the width of the area of the fully filtered pixels 610 is Block_Width−8 pixels.

The decoder system 600 applies the second filter 220 to the fully filtered pixels 610 to generate the second filtered pixels 620. The second filtered pixels 620 represent pixels to which both the first filter 210 and the second filter 220 have been applied. The decoder system 600 does not use the partly-filtered pixels 615 in generating the second filtered pixels 620. Thus, b columns of pixels remain as single-filtered pixels 625 to which the first filter 210 is applied, but the second filter 220 is not applied. The value of b can be based on the tap value M of the second filter 220, since the b columns of single-filtered pixels 625 are caused by the second filter 220 using but not modifying the b columns of single-filtered pixels 625. The value of b can be calculated as

$$b = \frac{M - 1}{2} + e .$$

Here, M is the tap value of the second filter 220. In some examples, e=0. In some examples, e is used to round b up to the nearest multiple of the size that the first filter 210 applies to (e.g., of the size of the width of a sub-block). The second filter 220 can be, for instance, the SAO filter 320, the ALF 330, the CDEF 420, the LR filter 440, another filter, or a combination thereof. For instance, if the second filter 220 is the SAO filter 320, then M=3. Thus, if the second filter 220 is the SAO filter 320, then

$$b = \frac{3 - 1}{2} + e = 1 + e .$$

If the sub-block size is 4×4 as illustrated in block layout 500 of FIG. 5, then e=3, so that b=4. On the other hand, if the second filter 220 is the CDEF filter 320, then M=5. Thus, if the second filter 220 is the CDEF 420, then

$$b = \frac{5 - 1}{2} + e = 2 + e .$$

The CDEF filter 320 applies to a 4×4 area in chroma, but to an 8×8 area in luma. Thus, e=6, so b=8.

Regardless, the width of the area of the second filtered pixels 620 is Block_Width−(a+b), which can also be written as Block_Width−a−b. For instance, if the first filter 210 is the DB filter 310 and the second filter 220 is the SAO filter 320 (e.g., as in the decoder system 300), then the width of the area of the second filtered pixels 620 is Block_Width−(8+4)=Block_Width−12 pixels. If the first filter 210 is the DB filter 310 and the second filter 220 is the CDEF 420 (e.g., as in the decoder system 400), then the width of the area of the second filtered pixels 620 is Block_Width−(8+8)=Block_Width−16 pixels.

The decoder system 600 stores pixel data into the neighboring block line buffer 250 to carry forward into the processing of the next block (e.g., the second block 515B if the current block is the first block 515A). Specifically, using the technique illustrated in FIG. 6, the decoder system 600 stores the a columns of the partly-filtered pixels 615, the b columns of the single-filtered pixels 625, and another set of c columns of single-filtered pixels 630 (e.g., with the first filter 210 applied but not the second filter 220) for use in applying the second filter 220 to the single-filtered pixels 625. The number c of columns of single-filtered pixels 630 can be based on the tap value M of the second filter 220. In some examples,

$$c = \frac{M - 1}{2} .$$

In some examples, c=b. For instance, if the second filter 220 is the SAO filter 320, then M=3. Thus, if the second filter 220 is the SAO filter 320, then

$$c = \frac{3 - 1}{2} = 1.$$

On the other hand, if the second filter 220 is the CDEF 420, then M=5. Thus, if the second filter 220 is the CDEF 420, then

$$c = \frac{5 - 1}{2} = 2.$$

Thus, the decoder system 600 stores at least a+b+c columns of pixels in the neighboring block line buffer 250 by the end of the block filtering process illustrated in FIG. 6. If the first filter 210 is the DB filter 310 and the second filter 220 is the SAO filter 320 (e.g., as in the decoder system 300), then the a+b+c columns of pixels stored in the neighboring block line buffer 250 include 8+4+1=13 columns of pixels. If the first filter 210 is the DB filter 310 and the second filter 220 is the CDEF 420 (e.g., as in the decoder system 400), then the a+b+c columns of pixels stored in the neighboring block line buffer 250 include 8+8+2=18 columns of pixels.

FIG. 7 is a block diagram illustrating a decoder system 700 that applies a first filter 210 and a second filter 220 to a block of video data, with partial sub-block application of the first filter 210 used to allow the second filter 220 to be applied to more of the block than under the decoder system 600 of FIG. 6. The decoder system 700 can be an example of the decoding device 112, the decoder engine 116, the decoder system 200, the codec system that performs the codec process 800, the computing system 900, or a combination thereof.

The decoder system 700 receives the reconstructed block pixels 605 as discussed with respect to the decoder system 600. The first filter 210 (e.g., DB filter 310) of the decoder system 700 performs DB filtering on the reconstructed block pixels 605 to generate the first filtered pixels 610 and the partly filtered pixels 615, as with the decoder system 600. However, in the decoder system 700, the first filter 210 (e.g., DB filter 310) of the decoder system 700 generates c filtered line(s) 705 to which the first filter 210 is applied. The decoder system 700 generates the c filtered line(s) 705 separately from the first filtered pixels 610 and/or from the partly filtered pixels 615. The first filter 210 is fully applied to the c filtered line(s) 705. For instance, if the first filter 210 is the DB filter 310, then the DB filter 310 is fully applied (e.g., both vertical DB filter 340 and horizontal DB filter 345) to the c filtered line(s) 705.

As noted with respect to FIG. 6, in some examples,

$$c = \frac{M - 1}{2} .$$

In some examples, c=b. For instance, if the second filter 220 is the SAO filter 320, then M=3. Thus, if the second filter 220 is the SAP filter 320, then

$$c = \frac{3 - 1}{2} = 1.$$

In some examples, if the second filter 220 is the SAO filter 320, the c filtered line(s) 705 include a filtered variant of the column C7 of the block layout 500. On the other hand, if the second filter 220 is the CDEF 420, then M=5. Thus, if the second filter 220 is the CDEF 420, then

$$c = \frac{5 - 1}{2} = 2.$$

In some examples, if the second filter 220 is the CDEF 420, the c filtered line(s) 705 include filtered variants of the two columns C6-C7 of the block layout 500.

In some examples, depending on the type of filter the first filter 210 is, the decoder system 700 may need to filter more than just the c filtered line(s) 705 to generate the c filtered line(s) 705. Regardless, the decoder system 700 provides the c filtered line(s) 705 to the second filter 220. Because the amount c of the c filtered line(s) 705 is chosen based on the tap value M of the second filter 220, the c filtered line(s) 705 provide the neighboring pixel data that the second filter 220 needs to omit generating the b columns of the single-filtered pixels 625 as in FIG. 6. Instead, the decoder system 700 of FIG. 7 is able to convert all of the first filtered pixels 610 into second filtered pixels 720 that are filtered using both the second filter 220 and the first filter 210. As a result, the decoder system 700 is able to filter more of the block using both the first filter 210 and the second filter 220 than the decoder system 600 was able to, with only the minimal additional work of generating the c filtered line(s) 705. Further, the decoder system 700 is able to store at least b columns less of pixel data in the neighboring block line buffer 250 than the decoder system 600 needed to, by no longer needing to store the b columns of the single-filtered pixels 625 in the neighboring block line buffer 250. If the second filter 220 is the SAO filter 320, the reduction by b represents 4 fewer columns of pixel data to store in the neighboring block line buffer 250. If the second filter 220 is the CDEF 420, the reduction by b represents 8 fewer columns of pixel data to store in the neighboring block line buffer 250.

It should be understood that additional filters can be used by the decoder system 600 and/or the decoder system 700, and can cause further data to be stored in the neighboring block line buffer 250. However, even with such additional filters, the reduction of b fewer columns of pixel data to store in the neighboring block line buffer 250 is maintained. For instance, an addition of a third filter 230 (such as the ALF 330 or the LR filter 440) can add a first set of columns of pixels to the neighboring block line buffer 250 that are filtered by the first filter 210 and the second filter 220 but not the third filter 230, as well as a second set of additional columns of pixels that are filtered by the first filter 210 and the second filter 220 but not the third filter 230 and that are to be used as neighbor pixels for applying the third filter 230 to the first set. Even with such a third filter, the above-discussed improvement by the decoder system 700 over the decoder system 600 persists, and in some cases can be further expanded. For instance, in some cases, for a decoding process with more filters, the generation and passing of filtered line(s) from one filter to the next filter (e.g., as in the generation of the c filtered line(s) 705 using the first filter 210 and the passing of the c filtered line(s) 705 to the second filter 220 to use as neighboring pixel data for application of the second filter 220) can be performed multiple times, for multiple pairs of filters, each time increasing how much of the block is processed and reducing how much needs to be stored in the neighboring block line buffer 250.

In some examples, the

$$Block\_Width \geq \frac{N - 1}{2} + \frac{M - 1}{2} .$$

In some examples, if the third filter 230 is added, then if

$$Block\_Width \geq \frac{M - 1}{2} + \frac{K - 1}{2} ,$$

the technique of FIG. 7 (e.g., generation and passing of filtered line(s) from one filter to the next filter) can be applied for the second filter 220 and the third filter 230, instead of or in addition to being applied for the first filter 210 and the second filter 220 as illustrated in FIG. 7.

In some examples, in the decoder system 700 with 4:2:0 chroma sub-sampling where the neighboring block is located to the left of the first block in the video frame, the amount of data written to, stored in, and read from the neighboring block line buffer 250 from and/or for the first filter 210 can be determined as indicated in Equation Set 4, for instance where the first filter is a DB filter 310 (e.g., as in the decoder system 300 and/or the decoder system 400).

In some examples, the technique illustrated in the decoder system 700 can be applied to a decoder system that in which the second filter 220 is an SAO filter 320 and/or an ALF 330, such as the decoder system 300. Application of the technique illustrated in the decoder system 700 to a decoder system in which the second filter 220 is an SAO filter 320 and/or an ALF 330 can result in reduction in how much block data needs to be stored in the neighboring block line buffer 250 compared to the decoder system 600 of FIG. 6, for instance as indicated in Equation Set 18 below:

$$SAO Luma left nbr buffer size = 1 * Luma\_Tile \_Height \\ SAO CB left buffer size = 1 * Luma\_Tile \_Height * 1 / 2 \\ SAO CR left buffer size = 1 * Luma\_Tile \_Height * 1 / 2 \\ ALF Luma left nbr buffer size = 7 * Luma\_Tile \_Height \\ ALF left buffer size = 6 * Luma\_Tile \_Height * 1 / 2 \\ ALF CR left buffer size = 6 * Luma\_Tile \_Height * 1 / 2 \\ Total DB + SAO + ALF left nbr buffer size = ( 27 * Luma\_Tile \_Height ) \\ Total left nbr buffer size = 27 * H pixels \\ Memory Bandwidth = 27 * H * F pixels / sec \qquad Equation Set 18$$

As is noticeable by comparing Equation Set 18 to Equation Set 5 and Equations 6-9, application of the technique illustrated in the decoder system 700 to a decoder system that in which the second filter 220 is an SAO filter 320 and/or an ALF 330, such as the decoder system 300, reduces an amount of data to be stored in the neighboring block line buffer 250 compared to use of the technique of the decoder system 600 of FIG. 6 with the same set of filters. For instance, according to the comparison above, the total left neighbor buffer size and the memory bandwidth needed are both reduced by 22.8%.

In some examples, the technique illustrated in the decoder system 700 can be applied to a decoder system that in which the second filter 220 is a CDEF 420, such as the decoder system 400. Application of the technique illustrated in the decoder system 700 to a decoder system in which the second filter 220 is a CDEF 420 can result in reduction in how much block data needs to be stored in the neighboring block line buffer 250 compared to the decoder system 600 of FIG. 6, for instance as indicated in Equation Set 19 below:

$$CDEF Luma left nbr buffer size = 2 * Luma\_Tile \_Height \\ CDEF CB left buffer size = 2 * Luma\_Tile \_Height * 1 / 2 \\ CDEF CR left buffer size = 2 * Luma\_Tile \_Height * 1 / 2 \\ Total ( DB + CDEF ) left nbr buffer size = ( 16 * Luma\_Tile \_Height ) \\ Total ( DB + CDEF ) left nbr buffer size = 16 * H pixels \\ Memory Bandwidth = 16 * H * F pixels / sec \qquad Equation Set 19$$

As is noticeable by comparing Equation Set 19 to Equation Set 14 and Equations 15-17, application of the technique illustrated in the decoder system 700 to a decoder system that in which the second filter 220 is a CDEF 420, such as the decoder system 400, reduces an amount of data to be stored in the neighboring block line buffer 250 compared to use of the technique of the decoder system 600 of FIG. 6 with the same set of filters. For instance, according to the comparison above, the total left neighbor buffer size and the memory bandwidth needed are both reduced by 42.9%.

Regardless of what filters are used for the first filter 210 and the second filter 220, the decoder system 700 of FIG. 7 reduces memory bandwidth usage for writing data to and/or reading data from the neighboring block line buffer 250 compared to the decoder system 600 of FIG. 6. The decoder system 700 of FIG. 7 makes these improvements over the decoder system 600 of FIG. 6 at least by fully applying the first filter 210 (e.g., DB filter 310) to a portion (the filtered lines 705) of a sub-block (e.g., sub-block 510B) of the block (the reconstructed block pixels 605). This allows the second filter 220 (e.g., SAO filter 320, ALF 330, and/or CDEF 420) of the decoder system 700 to apply full second filtering to a larger portion of the reconstructed block pixels 605 (e.g., the second filtered pixels 720 with width Block_Width−8) than the second filter 220 of the decoder system 600 is able to fully filter (e.g., the second filtered pixels 620 with width Block_Width−16).

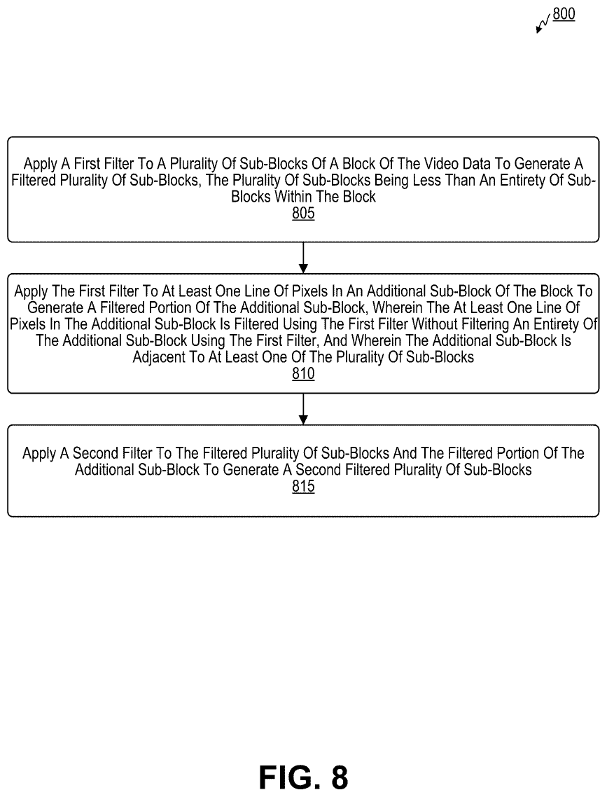

FIG. 8 is a flow diagram illustrating a codec process 800. The codec process 800 may be performed by a codec system. In some examples, the codec system can include, for example, the video source 102, the encoding device 104, the encoding engine 106, the storage 108, the output 110, the communications link 120, the decoding device 112, the input 114, the decoder engine 116, the storage 118, the video destination device 122, the decoder system 200, the first filter 210, the second filter 220, the third filter 230, the rescaler(s) 240, the neighboring block line buffer 250, the decoder system 300, the DB filter 310, the SAO filter 320, the ALF 330, the decoder system 400, the CDEF 420, the upscaler 430, the LR filter 440, the downscaler 450, the block layout 500, the decoder system 600, the decoder system 700, the computing system 900, the processor 910, an apparatus, a non-transitory computer-readable medium that stores instructions for execution by one or more processors, a mobile handset, a head-mounted display (HMD), a wireless communication device, or a combination thereof.

At operation 805, the codec system (or at least one component thereof) is configured to, and can, apply a first filter to a plurality of sub-blocks of a block of the video data to generate a filtered plurality of sub-blocks. The plurality of sub-blocks are less than an entirety of sub-blocks within the block. Examples of the first filter include the first filter 210, the second filter 220, the DB filter 310, the SAO filter 320, the CDEF 420, the first filter of FIG. 5, another filter discussed herein, or a combination thereof. Examples of the filtered plurality of sub-blocks can include the first filtered pixels 610, the sub-blocks 510A and 510E, and in some cases sub-blocks 510C-510D.

In some examples, the codec system a video encoder (e.g., encoding device 104, encoding engine 106) configured to encode the video data (e.g., stored in storage 108 and output as output 110). In some examples, the codec system (or at least one component thereof) is configured to, and can, receive (e.g., via input 114 over communication link 120) the video data from the video encoder before applying the first filter to the plurality of sub-blocks of the block.

At operation 810, the codec system (or at least one component thereof) is configured to, and can, apply the first filter to at least one line of pixels in an additional sub-block of the block to generate a filtered portion of the additional sub-block. The at least one line of pixels in the additional sub-block is filtered using the first filter without filtering an entirety of the additional sub-block using the first filter. The additional sub-block is adjacent to at least one of the plurality of sub-blocks. Examples of the at least one line least one line of pixels in an additional sub-block include line(s) of pixels of the sub-block 510B and/or the filtered line(s) 705.

In some examples, the additional sub-block is horizontally adjacent to the at least one of the plurality of sub-blocks. In some examples, the at least one line of pixels in the additional sub-block is adjacent to a vertical boundary between the additional sub-block and the at least one of the plurality of sub-blocks. For instance, in an illustrative example, the additional sub-block can be the sub-block 510B, the plurality of sub-blocks can include the sub-blocks 510C-510D, and the at least one line of pixels can include column C7 and/or column C6, which are adjacent to the vertical boundary V2 between the sub-block 510B and the sub-block 510C.

In some examples, the additional sub-block and each of the plurality of sub-blocks have a size of 4 pixels by 4 pixels, as in the sub-blocks 510A-510F illustrated in FIG. 5.

At operation 815, the codec system (or at least one component thereof) is configured to, and can, apply a second filter to the filtered plurality of sub-blocks and the filtered portion of the additional sub-block to generate a second filtered plurality of sub-blocks. Examples of the second filter include the second filter 220, the third filter 230, the SAO filter 320, the ALF 330, the CDEF 420, the LR filter 440, the second filter of FIG. 5, another filter discussed herein, or a combination thereof. Examples of the second filtered plurality of sub-blocks include the sub-blocks 510C-510D and the second filtered pixels 720.

In reference to FIG. 2 and/or FIGS. 6-7, in a first illustrative example, the first filter 210 is an example of the first filter of the process 800, and the second filter 220 is an example of the second filter of the process 800. In a second illustrative example, the first filter 210 is an example of the first filter of the process 800, and the third filter 230 is an example of the second filter of the process 800. In a third illustrative example, the second filter 220 is an example of the first filter of the process 800, and the third filter 230 is an example of the second filter of the process 800.

In reference to FIG. 3, in a first illustrative example, the DB filter 310 is an example of the first filter of the process 800, and the SAO filter 320 is an example of the second filter of the process 800. In a second illustrative example, the DB filter 310 is an example of the first filter of the process 800, and the ALF 330 is an example of the second filter of the process 800. In a third illustrative example, the SAO filter 320 is an example of the first filter of the process 800, and the ALF 330 is an example of the second filter of the process 800.

In reference to FIG. 4, in a first illustrative example, the DB filter 310 is an example of the first filter of the process 800, and the CDEF 420 is an example of the second filter of the process 800. In a second illustrative example, the DB filter 310 is an example of the first filter of the process 800, and the LR filter 440 is an example of the second filter of the process 800. In a third illustrative example, the CDEF 420 is an example of the first filter of the process 800, and the LR filter 440 is an example of the second filter of the process 800.

In reference to FIG. 5, in an illustrative example, the first filter of FIG. 5 is an example of the first filter of the process 800, and the second filter of FIG. 5 is an example of the second filter of the process 800.

In some examples, the codec system (or at least one component thereof) is configured to, and can, apply a third filter to the filtered plurality of sub-blocks and the filtered portion of the additional sub-block to generate a third-filtered plurality of sub-blocks. For instance, in a first illustrative example referencing FIG. 3, the first filter is a DB filter 310, the second filter is an SAO filter 320, and the third filter is an ALF 330. In a second illustrative example referencing FIG. 4, the first filter is a DB filter 310, the second filter is a CDEF 420, and the third filter is an LR filter 440.

In some examples, the first filter, the second filter, and/or the third filter can be, for instance, a DB filter 310, a vertical DB filter 340, a horizontal DB filter 45, an SAO filter 320, an ALF 330, a CDEF 420, an LR filter 440, an upscaler or upsampler (e.g., rescaler(s) 240, upscaler 430), a downscaler or downsampler (e.g., rescaler(s) 240, downscaler 450), a rescaler or resampler (e.g., rescaler(s) 240, upscaler 430, downscaler 450), a Gaussian filter, a blur filter, a semantic segmentation based filter, a filter that applies one or more machine learning model(s) (e.g., one or more neural network(s)), a Lanczos filter, a sub-pixel motion interpolation filter, a linear filter, a non-linear filter, a Wiener filter, a bilateral filter, a Gabor filter, a Gabor wavelet filter, a gray-level co-occurrence matrix (GLCM) filter, a bilinear interpolation filter, a bicubic interpolation filter, a trilinear interpolation filter, a tricubic interpolation filter, a nearest neighbor filter, an anti-aliasing filter, a super-resolution filter, a noise reduction filter, a sharpening filter, a tone mapping filter, a Sinc filter, a sinc-in-time filter, a sinc-in-frequency filter, a compression artifact removal filter, a Sobel filter, a high-pass filter, a low-pass filter, a bandpass filter, another filter, or a combination thereof.

In some examples, the at least one line of pixels in the additional sub-block includes a plurality lines of pixels in the block that are adjacent to one another, for instance including one or more lines of the sub-block 510B and/or the c lines of the filtered line(s) 705. In some examples, the second filter is an M-tap filter, and the at least one line of pixels in the additional sub-block includes an amount of lines of pixels that is based on M. For instance, in an illustrative example the amount of lines of pixels is based on, and/or equal to, (M−1)/2. In some examples, the first filter is an N-tap filter, and the at least one line of pixels in the additional sub-block includes an amount of lines of pixels that is based on N and a sub-block size. For instance, in an illustrative example the amount of lines of pixels is based on, and/or equal to, (N−1)/2.

In some examples, the first filter includes a deblocking (DB) filter, for instance as in FIGS. 3-4. In some examples, the second filter includes a Sample Adaptive Offset (SAO) filter and/or an Adaptive Loop Filter (ALF), as in FIG. 3. In some examples, the second filter includes a Constrained Directional Enhancement Filter (CDEF) and/or a Loop Restoration (LR) Filter, as in FIG. 4.

In some examples, the codec system (or at least one component thereof) is configured to, and can, store a partially-filtered portion of the block in a neighboring block buffer, where the partially-filtered portion of the block is partially filtered using the first filter. The codec system can apply at least one filter to the partially-filtered portion of the block from the neighboring block buffer and to a second block that neighbors the block to filter the second block. For instance, the partly-filtered pixels 615 can be an example of the partially-filtered portion of the block. The neighboring block line buffer 250 can be an example of the neighboring block buffer. In some examples, the first block 515A is an example of the block of the process 800, and the second block 515B is an example of the second block. In some examples, the partially-filtered portion of the block is part of the additional sub-block. For instance, in some examples, column(s) C4, C5, C6, and/or C7 can be partially filtered using the first filter. In some examples, partial filtering can include, for instance, filtering vertically but not horizontally, or vice versa. For instance, if the first filter is a DB filter 310, then the partially-filtered portion of the block can have the vertical DB filter 340 applied without having the horizontal DB filter 345 applied, or vice versa.

In some examples, the codec system (or at least one component thereof) is configured to, and can, apply the second filter to a second set of at least one line of pixels in the additional sub-block of the block to generate a second filtered portion of the additional sub-block. The second set of at least one line of pixels in the additional sub-block is filtered using the second filter without filtering an entirety of the additional sub-block using the second filter. In some examples, the codec system (or at least one component thereof) is configured to, and can, apply a third filter to the second filtered plurality of sub-blocks and the second filtered portion of the additional sub-block to generate a third filtered plurality of sub-blocks. For instance, FIG. 7 could be modified to add a third filter after the second filter 220, and to add a second set of filtered line(s) between the second filter 220 and the third filter (similar to the filtered line(s) 705 between the first filter 210 and the second filter 220 in FIG. 7). In this way, the amount stored in the neighboring block line buffer 250 can reduce further, similarly to the reduction in the amount stored in the neighboring block line buffer 250 between FIG. 6 and FIG. 7.

In some examples, the codec system (or at least one component thereof) is configured to, and can, rescale pixel data of at least one of the video data, the filtered plurality of sub-blocks, the filtered portion of the additional sub-block, the second filtered plurality of sub-blocks, or a combination thereof. For instance rescaling the pixel data can be performed using rescaler(s) 240, upscaler(s) 430, downscaler(s) 450, or a combination thereof. Downscaling pixel data before applying a filter reduces the amount of pixels to which the filter is to be applied, and can therefore reduce computational resources that are required to apply the filter the pixel data.

In some examples, the codec system (or at least one component thereof) is configured to, and can, output output block data for storage in the at least one memory (e.g., storage 118, video destination device 122, cache 912, memory 915, ROM 920, RAM 925, storage device 930, output device 935). The output block data includes, is, and/or is based on the second filtered plurality of sub-blocks. In some examples, the codec system (or at least one component thereof) is configured to, and can, display output block data using a display (e.g., video destination device 122, output device 935).

In some examples, the codec system (or at least one component thereof) includes at least one of a head-mounted display (HMD), a mobile handset, or a wireless communication device.

In some examples, the processes described herein (e.g., the respective processes of FIGS. 1, 2, 3, 4, 5, 6, 7, the codec process 800 of FIG. 8, and/or other processes described herein) may be performed by a computing device or apparatus. In some examples, the processes described herein can be performed by, and/or using, the video source 102, the encoding device 104, the encoding engine 106, the storage 108, the output 110, the communications link 120, the decoding device 112, the input 114, the decoder engine 116, the storage 118, the video destination device 122, the decoder system 200, the first filter 210, the second filter 220, the third filter 230, the rescaler(s) 240, the neighboring block line buffer 250, the decoder system 300, the DB filter 310, the SAO filter 320, the ALF 330, the decoder system 400, the CDEF 420, the upscaler 430, the LR filter 440, the downscaler 450, the block layout 500, the decoder system 600, the decoder system 700, the computing system 900, the processor 910, an apparatus, a non-transitory computer-readable medium that stores instructions for execution by one or more processors, a mobile handset, a head-mounted display (HMD), a wireless communication device, or a combination thereof.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes. In some examples, performance of certain operations described herein can be responsive to performance of other operations described herein.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

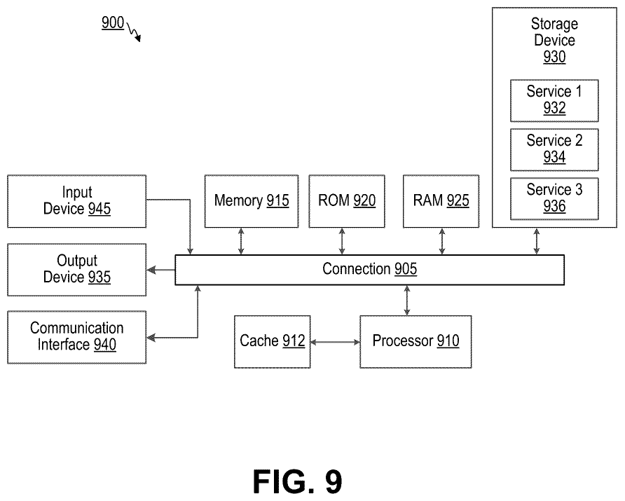

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 902.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1: An apparatus for media processing, the apparatus comprising: a memory; and one or more processors coupled to the memory, the one or more processors configured to: apply a first filter to a plurality of sub-blocks of a block of video data to generate a filtered plurality of sub-blocks, the plurality of sub-blocks being less than an entirety of sub-blocks within the block; apply the first filter to at least one line of pixels in an additional sub-block of the block to generate a filtered portion of the additional sub-block, wherein the at least one line of pixels in the additional sub-block is filtered using the first filter without filtering an entirety of the additional sub-block using the first filter, and wherein the additional sub-block is adjacent to at least one of the plurality of sub-blocks; and apply a second filter to the filtered plurality of sub-blocks and the filtered portion of the additional sub-block to generate a second filtered plurality of sub-blocks.

Aspect 2. The apparatus of Aspect 1, wherein the at least one line of pixels in the additional sub-block includes a plurality lines of pixels in the block that are adjacent to one another.

Aspect 3. The apparatus of any of Aspects 1 to 2, wherein the second filter is an M-tap filter, wherein the at least one line of pixels in the additional sub-block includes an amount of lines of pixels that is based on M.

Aspect 4. The apparatus of Aspect 3, wherein the amount of lines of pixels is (M−1)/2.

Aspect 5. The apparatus of any of Aspects 1 to 4, wherein the first filter is an N-tap filter, wherein the at least one line of pixels in the additional sub-block includes an amount of lines of pixels that is based on N and a sub-block size.

Aspect 6. The apparatus of any of Aspects 1 to 5, wherein the first filter includes a deblocking (DB) filter.

Aspect 7. The apparatus of any of Aspects 1 to 6, wherein the second filter includes at least one of a Sample Adaptive Offset (SAO) filter or an Adaptive Loop Filter (ALF).

Aspect 8. The apparatus of any of Aspects 1 to 7, wherein the second filter includes at least one of a Constrained Directional Enhancement Filter (CDEF) or a Loop Restoration (LR) Filter.

Aspect 9. The apparatus of any of Aspects 1 to 8, wherein the additional sub-block is horizontally adjacent to the at least one of the plurality of sub-blocks, wherein the at least one line of pixels in the additional sub-block is adjacent to a vertical boundary between the additional sub-block and the at least one of the plurality of sub-blocks.

Aspect 10. The apparatus of any of Aspects 1 to 9, wherein the additional sub-block and each of the plurality of sub-blocks have a size of 4 pixels by 4 pixels.

Aspect 11. The apparatus of any of Aspects 1 to 10, wherein the at least one processor is configured to: store a partially-filtered portion of the block in a neighboring block buffer, wherein the partially-filtered portion of the block is partially filtered using the first filter; and apply at least one filter to the partially-filtered portion of the block from the neighboring block buffer and to a second block that neighbors the block to filter the second block.

Aspect 12. The apparatus of Aspect 11, wherein the partially-filtered portion of the block is part of the additional sub-block.

Aspect 13. The apparatus of any of Aspects 1 to 12, wherein the at least one processor is configured to: apply a third filter to the filtered plurality of sub-blocks and the filtered portion of the additional sub-block to generate a third-filtered plurality of sub-blocks.

Aspect 14. The apparatus of any of Aspects 1 to 13, wherein the at least one processor is configured to: apply the second filter to a second set of at least one line of pixels in the additional sub-block of the block to generate a second filtered portion of the additional sub-block, wherein the second set of at least one line of pixels in the additional sub-block is filtered using the second filter without filtering an entirety of the additional sub-block using the second filter; and apply a third filter to the second filtered plurality of sub-blocks and the second filtered portion of the additional sub-block to generate a third filtered plurality of sub-blocks.

Aspect 15. The apparatus of any of Aspects 1 to 14, wherein the at least one processor is configured to: rescale pixel data of at least one of the video data, the filtered plurality of sub-blocks, the filtered portion of the additional sub-block, or the second filtered plurality of sub-blocks.

Aspect 16. The apparatus of any of Aspects 1 to 15, further comprising: a video encoder configured to encode the video data, wherein the at least one processor is configured to receive the video data from the video encoder before applying the first filter to the plurality of sub-blocks of the block.

Aspect 17. The apparatus of any of Aspects 1 to 16, wherein the at least one processor is configured to: output output block data for storage in the at least one memory, wherein the output block data is based on the second filtered plurality of sub-blocks.

Aspect 18. The apparatus of any of Aspects 1 to 17, wherein the at least one processor is configured to: display output block data using a display, wherein the output block data is based on the second filtered plurality of sub-blocks.

Aspect 19. The apparatus of any of Aspects 1 to 18, wherein the apparatus includes at least one of a head-mounted display (HMD), a mobile handset, or a wireless communication device.

Aspect 20. A method for video decoding, the method comprising: applying a first filter to a plurality of sub-blocks of a block of video data to generate a filtered plurality of sub-blocks, the plurality of sub-blocks being less than an entirety of sub-blocks within the block; applying the first filter to at least one line of pixels in an additional sub-block of the block to generate a filtered portion of the additional sub-block, wherein the at least one line of pixels in the additional sub-block is filtered using the first filter without filtering an entirety of the additional sub-block using the first filter, and wherein the additional sub-block is adjacent to at least one of the plurality of sub-blocks; and applying a second filter to the filtered plurality of sub-blocks and the filtered portion of the additional sub-block to generate a second filtered plurality of sub-blocks.

Aspect 21. A non-transitory computer-readable medium having stored thereon instructions that, when executed by one or more processors, cause the one or more processors to perform operations according to any of Aspects 1 to 20.

Aspect 22. An apparatus for imaging, the apparatus comprising one or more means for performing operations according to any of Aspects 1 to 20.

What is claimed is:

1. An apparatus for video decoding, the apparatus comprising:
at least one memory configured; and
at least one processor coupled to the at least one memory, the at least one processor configured to:
apply a first filter to a plurality of sub-blocks of a block of video data to generate a filtered plurality of sub-blocks, the plurality of sub-blocks being less than an entirety of sub-blocks within the block;
apply the first filter to at least one line of pixels in an additional sub-block of the block to generate a filtered portion of the additional sub-block, wherein the at least one line of pixels in the additional sub-block is filtered using the first filter without filtering an entirety of the additional sub-block using the first filter, and wherein the additional sub-block is adjacent to at least one of the plurality of sub-blocks; and
apply a second filter to the filtered plurality of sub-blocks and the filtered portion of the additional sub-block to generate a second filtered plurality of sub-blocks.

2. The apparatus of claim 1, wherein the at least one line of pixels in the additional sub-block includes a plurality lines of pixels in the block that are adjacent to one another.

3. The apparatus of claim 1, wherein the second filter is an M-tap filter, wherein the at least one line of pixels in the additional sub-block includes an amount of lines of pixels that is based on M.

4. The apparatus of claim 3, wherein the amount of lines of pixels is (M−1)/2.

5. The apparatus of claim 1, wherein the first filter is an N-tap filter, wherein the at least one line of pixels in the additional sub-block includes an amount of lines of pixels that is based on N and a sub-block size.

6. The apparatus of claim 1, wherein the first filter includes a deblocking (DB) filter.

7. The apparatus of claim 1, wherein the second filter includes at least one of a Sample Adaptive Offset (SAO) filter or an Adaptive Loop Filter (ALF).

8. The apparatus of claim 1, wherein the second filter includes at least one of a Constrained Directional Enhancement Filter (CDEF) or a Loop Restoration (LR) Filter.

9. The apparatus of claim 1, wherein the additional sub-block is horizontally adjacent to the at least one of the plurality of sub-blocks, wherein the at least one line of pixels in the additional sub-block is adjacent to a vertical boundary between the additional sub-block and at least the one of the plurality of sub-blocks.

10. The apparatus of claim 1, wherein the additional sub-block and each of the plurality of sub-blocks have a size of 4 pixels by 4 pixels.

11. The apparatus of claim 1, wherein the at least one processor is configured to:
store a partially-filtered portion of the block in a neighboring block buffer, wherein the partially-filtered portion of the block is partially filtered using the first filter; and
apply at least one filter to the partially-filtered portion of the block from the neighboring block buffer and to a second block that neighbors the block to filter the second block.

12. The apparatus of claim 11, wherein the partially-filtered portion of the block is part of the additional sub-block.

13. The apparatus of claim 1, wherein the at least one processor is configured to:
apply a third filter to the filtered plurality of sub-blocks and the filtered portion of the additional sub-block to generate a third-filtered plurality of sub-blocks.

14. The apparatus of claim 1, wherein the at least one processor is configured to:
apply the second filter to a second set of at least one line of pixels in the additional sub-block of the block to generate a second filtered portion of the additional sub-block, wherein the second set of at least one line of pixels in the additional sub-block is filtered using the second filter without filtering an entirety of the additional sub-block using the second filter; and
apply a third filter to the second filtered plurality of sub-blocks and the second filtered portion of the additional sub-block to generate a third filtered plurality of sub-blocks.

15. The apparatus of claim 1, wherein the at least one processor is configured to:
rescale pixel data of at least one of the video data, the filtered plurality of sub-blocks, the filtered portion of the additional sub-block, or the second filtered plurality of sub-blocks.

16. The apparatus of claim 1, further comprising:
a video encoder configured to encode the video data, wherein the at least one processor is configured to receive the video data from the video encoder before applying the first filter to the plurality of sub-blocks of the block.

17. The apparatus of claim 1, wherein the at least one processor is configured to:
output output block data for storage in the at least one memory, wherein the output block data is based on the second filtered plurality of sub-blocks.

18. The apparatus of claim 1, wherein the at least one processor is configured to:
display output block data using a display, wherein the output block data is based on the second filtered plurality of sub-blocks.

19. The apparatus of claim 1, wherein the apparatus includes at least one of a head-mounted display (HMD), a mobile handset, or a wireless communication device.

20. A method for video decoding, the method comprising:
applying a first filter to a plurality of sub-blocks of a block of video data to generate a filtered plurality of sub-blocks, the plurality of sub-blocks being less than an entirety of sub-blocks within the block;
applying the first filter to at least one line of pixels in an additional sub-block of the block to generate a filtered portion of the additional sub-block, wherein the at least one line of pixels in the additional sub-block is filtered using the first filter without filtering an entirety of the additional sub-block using the first filter, and wherein the additional sub-block is adjacent to at least one of the plurality of sub-blocks; and
applying a second filter to the filtered plurality of sub-blocks and the filtered portion of the additional sub-block to generate a second filtered plurality of sub-blocks.
